(19) United States
(12) Patent Application Publication
(10) Pub. No.: US 2007/0265896 A1
(43) Pub. Date: Nov. 15, 2007

(54) System for valuing multiple solutions in multiple value categories

(75) Inventor: Peter L. Smith, Seattle, WA (US)

Correspondence Address: TUNG & ASSOCIATES, Suite 120, 838 W. Long Lake Road, Bloomfield Hills, MI, 48302, US

(73) Assignee: The Boeing Company

(21) Appl. No.: 11/433,709

(22) Filed: May 12, 2006

(51) Int. Cl. G06F 9/44; G06Q 10/00; G06F 17/00

(52) U.S. Cl. 705/7; 705/1; 715/503

(57) ABSTRACT

A system is provided for evaluating the quantitative impact of multiple solutions for improving enterprise operations in multiple value categories. Spreadsheet workbooks controlled by a programmed computer are used to analyze the “many-to-many” relationships between the multiple solutions and the multiple value categories. The workbooks are initially populated with “as is” key parameters representing an existing model of the operations. The computer calculates “what if” key parameter values representing the model with use of a selected solution, populates the workbooks with the “what if” values and then calculates the economic benefit of the selected solution in each of the value categories. The workbooks are linked such that a change to a key parameter in one workbook is automatically repeated in the other workbooks.

### FIELD OF THE INVENTION

This invention generally relates to techniques for evaluating proposed solutions for improving the operations of an enterprise, and deals more particularly with a system for determining the economic benefit of multiple solutions in multiple value categories.

### BACKGROUND OF THE INVENTION

An airline or other large commercial or non-commercial enterprise typically requires the coordinated efforts of many different functional groups. Generally, each of the different groups is responsible for managing a different part of the enterprise. A typical airline, for example, can include different functional groups for managing flight operations, aircraft maintenance, passenger services, and other aspects of the business necessary for day-to-day operations. The efficiency with which these different functional groups cooperate to run the airline can have a direct effect on the profitability and, ultimately, the success of the airline in a competitive marketplace.

Conventional methods for modeling the complex operations of airlines and other large enterprises typically include process flow charts and other types of schematic diagrams that attempt to illustrate the inter-workings of the different functional groups. Although these methods may illustrate some functional relationships at a relatively high level, they are of limited value in analyzing process interactions because they typically lack detailed information about the various attributes (e.g., cost, time, etc.) associated with each process.

One problem facing companies that produce and market such products and services is how to justify the investment in the product or service to the airline operator. That is, how best to make the business case to the potential customer. A typical marketing approach is to “demo” the product or service using a fictitious business model. The downside of this approach, however, is that the fictitious model may or may not be a realistic simulation of the actual airline. As a result, the airline operator may have a hard time visualizing and understanding the benefits of the product or service, and may remain unconvinced of the value to their airline.

Proving the value of goods and services forming a “solution” to improving enterprise operations is difficult where the business case depends on assessing the impact of the solution on the operations, such as those of a commercial airline where operating efficiencies depend on a complex set of interrelated variables. The problem becomes more challenging where there are multiple possible solutions for improving enterprise operations that must be evaluated relative to each other in order to determine the optimum solution. Customers typically want to know the economic impact of a proposed solution on multiple areas of their operations; consequently it is necessary to determine the economic benefit of multiple solutions in each of several “value categories”. For example, the customer may want to know the quantitative impact of each of the solutions on the availability or reliability of aircraft, aircraft financing, maintenance, operating overhead, inventory, flight efficiency, and administration or facility requirements.

Based on the customer needs described above, it is apparent that a number of valuation scenarios must be separately calculated and presented to the customer. This process is not only time consuming, but the results are difficult to present in a manner that allows the customer to quickly compare the benefits of multiple solutions, in multiple value categories. Moreover, the multiple calculations must be repeated each time the customer wishes to change an operating assumption, such as the number of a certain aircraft in inventory, upon which the calculations are based.

Accordingly, there is a need for a system for determining the value of multiple solutions for improving enterprise operations in multiple value categories. The present invention is directed toward satisfying this need.

### SUMMARY OF THE INVENTION

In accordance with one aspect of the invention, a method is provided for determining the value of products or services representing solutions for improving enterprise operations, comprising the steps of: populating a set of computer spreadsheets with key parameters representing a model of enterprise operations; linking the spreadsheets, such that a change in one of the spreadsheets results in corresponding changes in the other spreadsheets; selecting a solution for improving the enterprise operations; calculating the benefit of the solution in at least one of a plurality of value categories using the key parameters; and, displaying a set of data in the spreadsheets representing the calculated benefit. A user may alter the values of at least certain of the key parameters in the spreadsheets in order to reflect a variation of the enterprise model. The method may further comprise providing a plurality of sets of enterprise operating data respectively representing differing enterprise operating profiles, selecting one of the operating data sets and using the selected data set as at least part of the key parameters used to populate the spreadsheets. Population of the spreadsheets includes simultaneously entering first and second sets of operating data wherein the first set of data represents enterprise operating characteristics without the use of a selected solution, and the second set of data represents enterprise operating characteristics with use of the selected solution. The step of calculating the benefit includes calculating the total economic benefit of the solution for all of the value categories, based on the first and second sets of operating data.

In accordance with another aspect of the invention, a method is provided for evaluating products or services representing solutions for improving enterprise operations, comprising the steps of: selecting a solution; selecting an operating profile for the enterprise operations; populating a set of computer software spreadsheets with “as is” key parameters representing a model of the enterprise operations without use of a selected solution; calculating a set of “what if” key parameters representing the model of the enterprise operations if the selected solution is used; populating the spreadsheets with the “what if” key parameters; and, calculating the benefit of the selected solution in at least one value category using the “as is” and “what if” values of the key parameters from the spreadsheets. The method may further comprise selecting a plurality of the solutions, and calculating the “what if” key parameter values based on use of each of the selected solutions. Calculation of the benefits preferably includes calculating the benefit of the selected solution in each of a plurality of value categories. A layout page may be linked to the spreadsheets and the calculated benefit may be displayed in the layout page.

In accordance with still another aspect of the invention, a system is provided for evaluating proposed solutions to improve the enterprise operations. The system comprises: a first software spreadsheet workbook containing information representing a plurality of solutions for improving the operations of an enterprise; a second software spreadsheet workbook containing information representing a plurality of value models for assessing the value of improvements provided by each of the solutions; a third software spreadsheet workbook linking the first and second workbooks, the third workbook containing key parameters representing a model of the enterprise operations; and, a computer programmed for accessing the information in each of the workbooks and for calculating the value of the improvements provided by each of the solutions for each of the value models using the key parameters. Each of the workbooks preferably includes a spreadsheet having first and second sets of key parameter values wherein the first set represents the model without the improvements provided by the solutions and the second set represents the model with the improvements provided by one of the solutions. One of the workbooks preferably includes a layout spreadsheet in which a user may alter the key parameters in order to customize the enterprise operations model. One of the workbooks also preferably includes a spreadsheet providing a user interface for displaying information related to the value of the improvements. Each of the workbooks preferably includes an interface spreadsheet containing first and second sets of key parameter values respectively representing the model with and without improvements provided by the solutions. The interface spreadsheets are preferably linked such that a change in a key parameter in one of the spreadsheets results in the same change occurring to the identical key parameter in the other spreadsheets.

The system of the present invention is advantageous in that it allows many proposed solutions to be quickly evaluated in multiple value categories that are significant to a customer's enterprise operation. The use of linked spreadsheets allows the customer to examine multiple “what if” scenarios for multiple proposed solutions. Another feature of the invention resides in the ability of the customer to customize the profiles of the enterprise operations, thereby allowing the customer to better determine which of the solutions provides the most benefit for each variation of the basic operator profile. Further, the customer is able to determine which of the solutions provides the most economic benefit in each of the value categories deemed most important to the customer. The same procedure is used to value each of the solutions, thus assuring an accurate comparison of the economic results for all of the solutions.

Various additional objects, features and advantages of the present invention can be more fully appreciated with reference to the detailed description and accompanying drawings that follow.

### BRIEF DESCRIPTION OF THE DRAWINGS

FIG. 1 is a schematic diagram of a system suitable for implementing various embodiments of the present invention.

FIG. 2 is a flow diagram illustrating a process for simulating and/or valuing the effects of various products and/or services on an operational model.

FIG. 3 is a flow diagram illustrating a routine for displaying a “what if” event model and providing various forms of output relating to the event model.

FIG. 4 is a schematic diagram of a display page presenting aircraft fleet information.

FIG. 5A is a schematic diagram of a display page illustrating an airline process model, and FIGS. 5B-I illustrate enlarged portions of the airline process model of FIG. 5A.

FIG. 6 is a schematic diagram of a display page illustrating an enlarged portion of the airline process model of FIG. 5 for the purpose of graphically illustrating how different functional groups in the model respond to challenges and events that occur in day-to-day operations.

FIG. 7 is a schematic diagram of a display page for selecting a “challenge” and an associated “event”.

FIG. 8 is a schematic diagram of a display page that graphically illustrates an “as is” event model.

FIG. 9 is schematic diagram of a display page for reviewing and/or editing attributes of a particular function.

FIG. 10 is a schematic diagram of a display page for selecting a “what if’ case.

FIG. 11 is a schematic diagram of a display page listing user options after a “what if” case has been created.

FIG. 12 is a schematic diagram of a display page that graphically illustrates a “what if’ event model.

FIG. 13 is a schematic diagram of a display page that provides information about existing “as is” and “what if” event cases.

FIG. 14 is a schematic diagram of a display page for comparing costs associated with an “as is” model to costs associated with a corresponding “what if’ model.

FIG. 15 is a schematic diagram of a display page that graphically describes the results of comparative analyses between an “as is” case and a corresponding “what if” case.

FIG. 16 is a schematic diagram of a display page that enables a user to “scale-up” benefits associated with selected products and services.

FIG. 17 is a schematic diagram of a display page providing airline schedule performance data.

FIG. 18 is a broad block diagram useful in explaining the concept of how key parameters are used to link a plurality of proposed solutions with a plurality of value categories forming an economic model used to evaluate the benefits of the solutions.

FIG. 19 is a block diagram showing how the spreadsheet workbooks are linked together and controlled by a programmed computer through a user interface.

FIG. 20 is a diagram schematically showing key elements in each of the workbooks and tracing the order of steps used to evaluate a selected solution.

FIG. 21 is a view of a computer screen, showing the interface worksheet forming part of the key parameters workbook.

FIG. 22 is a view of a computer screen showing the interface worksheet for the solutions workbook.

FIG. 23 is a view of a computer screen showing a spreadsheet containing “what if” values for each of the solutions contained in the key parameters workbook.

FIG. 24 is a view of a computer screen showing the interface spreadsheet forming part of the economic model workbook.

FIG. 25 is a view of a computer screen showing a layout worksheet forming a part of the economic model workbook.

FIG. 26 is a view of a computer screen representing a translation of the worksheet shown in FIG. 25, showing the user interface useful in changing economic ground rules.

FIG. 27 is a view of a computer screen showing another layout worksheet forming part of the economic model workbook.

FIG. 28 is a view of a computer screen representing a translation of the worksheet shown in FIG. 27, showing the user interface wherein calculated economic benefits of a selected solution are shown in graphical form.

FIG. 29 is a flow diagram showing the detailed steps for carrying out the method of the present invention.

### DETAILED DESCRIPTION OF THE PREFERRED EMBODIMENTS

The following disclosure describes computer-implemented methods and systems for modeling the operations of airlines and other commercial and non-commercial industries, and for simulating and valuing the effects of different products and services on those operations, such as solutions for reducing service disruptions. Specific details of several embodiments of the invention are described below to provide a thorough understanding of the embodiments. Other details describing well-known aspects of airlines and airline operational systems are not set forth below, however, to avoid unnecessarily obscuring the description of the various embodiments. Furthermore, although various embodiments of the invention are described below, those of ordinary skill in the art will understand that the invention can have other embodiments in addition to those described below. Such embodiments may lack one or more of the elements described below or, conversely, they may include other elements in addition to those described below.

Certain embodiments are described below in the context of computer-executable instructions performed by a general-purpose computer, such as a personal computer. The computer-executable instructions can be stored on various types of computer-readable media including, for example, hard disks, floppy disks, or a CD-ROMs. In other embodiments, these instructions can be stored on a server computer system and accessed via a computer network such as an intranet or the Internet. Because the basic structures and functions often associated with computer systems and related routines are well known, they have not been shown or described in detail here to avoid unnecessarily obscuring the described embodiments.

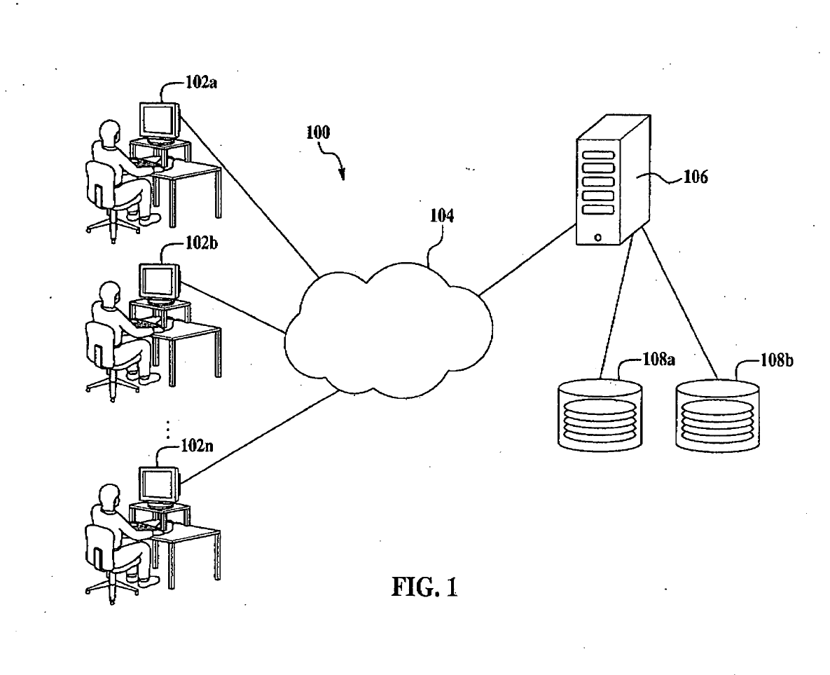

In the Figures, identical reference numbers identify identical or at least generally similar elements. To facilitate the discussion of any particular element, the most significant digit or digits of any reference number refer to the Fig. in which that element is first introduced. For example, element 110 is first introduced and discussed with reference to FIG. 1.

FIG. 1 is a schematic diagram of a system 100 suitable for implementing various embodiments of the present invention. The system 100 can include a plurality of user computers 102a-n operably connected to a server computer 106 via a communications link 104. Each of the user computers 102 can include a central processing unit, memory devices, input devices (e.g., a keyboard and a pointing device), output devices (e.g., a display screen or other device), and data storage devices (e.g., disk drives). The memory and storage devices can include computer-readable media that contain computer-executable instructions for implementing many of the processes, routines, and display pages of the present invention. As described in greater detail below, these processes, routines, and display pages can be used to model the various operational processes of an airline and graphically simulating the value that various products and services can have on those processes.

The user computers 102 can further include a browser module (not shown) that enables a user to access and exchange data with the server computer 106 and other sites via the communications link 104. The communications link 104 can be a computer network, such as a local area network (LAN), an intranet, or the Internet. The communications link 104 can be implemented using any one of a wide variety of conventional communications configurations including both wired and wireless types. Further, any of a wide variety of communications protocols can be used to transmit data via the communications link 104, including both public and proprietary protocols. The server computer 106 can be configured to retrieve data from a plurality of databases 108a-b and transmit the data in various forms to the user computers 102 via the communications link 104. Such data can include, for example, various information about different airlines, such as fleet size and make-up, routes, etc.

The system 100 is but one example of a suitable system for implementing various embodiments of the invention as described in greater detail below. Accordingly, the methods and systems disclosed herein are not limited to implementation on the system 100, but can be implemented on other types of general- and/or special-purpose computing systems or configurations. Examples of well-known computing systems, environments, and/or configurations that may be suitable for use with aspects of the invention include personal computers (PCs), server computers, portable and hand-held devices such as personal digital assistants (PDAs), laptop and tablet PCs, multiprocessor systems, microprocessor-based systems, set-top boxes, programmable consumer electronics, network PCs, mini-computers, mainframe computers, and/or distributed computing environments that include one or more of the above systems or devices.

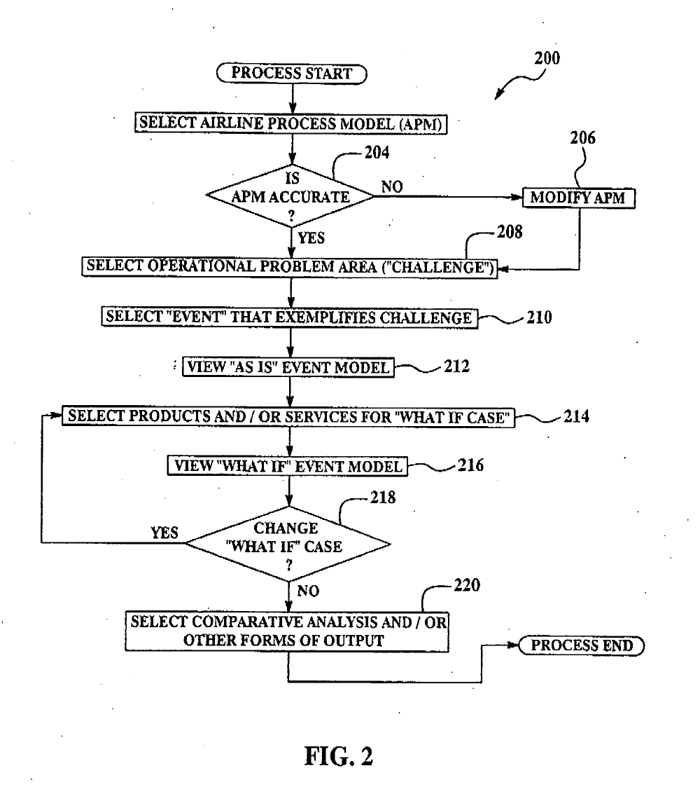

FIG. 2 is a flow diagram illustrating a process 200 for simulating and/or valuing the effects of various products and/or services on an operational model. In one aspect of this embodiment, the process 200 can be performed by a sales agent of the products and services by operating one of the user computers 102 described above with reference to FIG. 1. The sales agent may be performing the process 200 for the benefit of a potential customer who is interested in seeing if there is a business case that would justify purchasing the products and services.

For purposes of illustration, the process 200 is described below in the context of an airline process model. Thus, in this particular embodiment, the process 200 can be used by a seller of airline-related products and services to demonstrate the benefits of the products and services to a potential customer, i.e., an airline operator. As described in greater detail below, such airline-related products and services can include, for example, various software products, database systems, document management systems, and hand-held computational devices that facilitate efficient airline operation. Although the process 200 is described below in an airline context, those of ordinary skill in the art will appreciate that other embodiments of the invention can be used in other commercial and noncommercial industries in various business sectors including both transportation and non-transportation related enterprises. Such industries can include, for example, marine, ground, and space transportation industries; military fleet operations; etc.

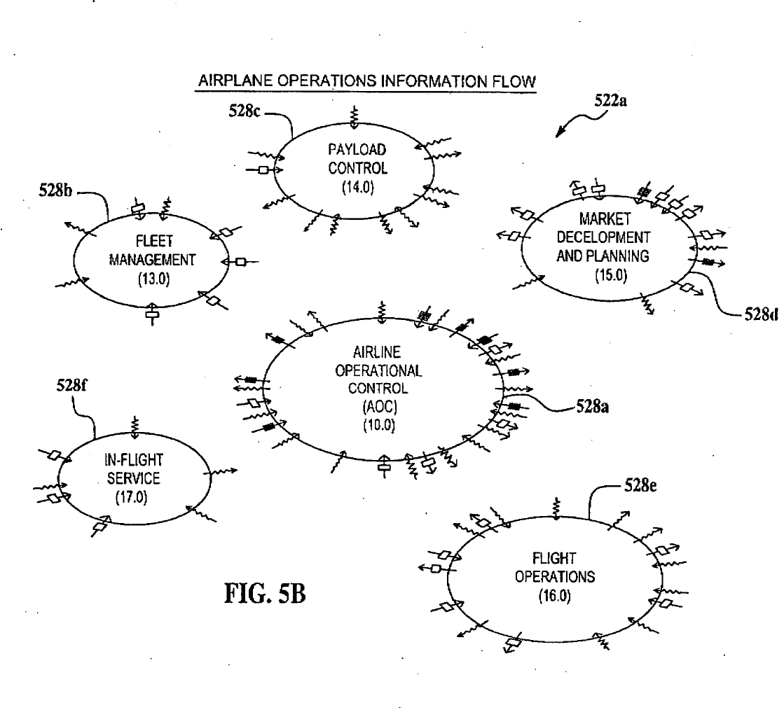

In the illustrated embodiment, the process 200 begins in block 202 with the selection of an “as is” airline process model (APM). As used herein, the term “as is” APM refers to an organized assembly of graphical and/or numerical data that describes functions, processes, information elements, and/or other parts of a global air transportation system (GATS). An example of an “as is” APM is described in greater detail below with reference to FIG. 5. In this embodiment, selecting the “as is” APM causes the APM to be displayed on a display screen or other suitable viewing device. The user (e.g., a sales agent) and/or others (e.g., an airline operator) can then view the “as is” APM to gain a better understanding of how the various functional groups in the airline currently interact during normal day-to-day operations. Further, in decision block 204, the user can determine if the “as is” APM accurately reflects the user's understanding of the current airline processes. If not, the user can modify the “as is” APM in block 206. As described in greater detail below, this modification can take the form of manipulating graphical data on the display screen and/or, alternatively, accessing a database to change various input data used to generate the “as is” APM.

After modifying the “as is” APM, or if the “as is” APM was accurate as initially displayed, the user can proceed to block 208 and select an area of the “as is” APM that the user feels needs improvement from, for example, a cost, schedule, or efficiency standpoint. In the present disclosure, such problem areas are referred to as “challenges,” and can relate to, for example, certain aspects of aircraft maintenance, flight schedule reliability, pilot log book entries, etc.

After selecting a challenge, the user can select an “event” in block 210 that is otherwise associated with the selected challenge. In this embodiment, the term “event” refers to a particular operational circumstance to which the “as is” APM responds. For example, a fuel indicator malfunction is an event that is associated with the challenge of maintaining aircraft schedule reliability.

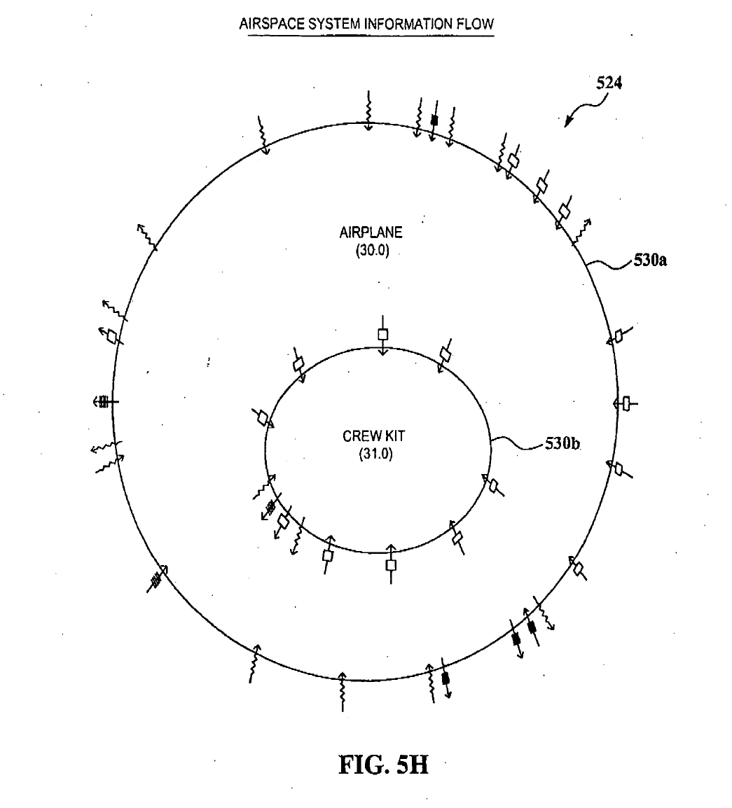

After the user has selected a challenge and one or more corresponding events, an “as is event model can be displayed for viewing by the user. An example of an “as is” event model is described in greater detail below with reference to FIG. 10. In one aspect of this embodiment, the “as is” event model can be a portion of the overall “as is” APM that graphically illustrates the sequence of functions that must be executed by the portion of the “as is” APM to respond to the selected event. That is, the “as is” event model provides a graphical simulation of the event-specific path for responding to the selected event. Viewing the “as is” event model allows the user to gain a better understanding of the various functional groups that have to respond to a particular event in the “as is” APM. Further, by viewing this model, the user is able to identify where inefficient processes exist leading to increased time or cost impacts to operations. With this information in mind, the user can proceed to block 214 and select one or more products and/or services that, when implemented, enable the APM to respond to the particular event in a more efficient and less costly manner. After the various products and/or services have been selected, the user can proceed to block 216 and view a “what if” event model.

In a further aspect of this embodiment, the “what if’ event model is similar to the “as is” event model in that it reproduces a particular portion of the overall APM. However, the “what if’ event model differs from the “as is event model in that the “what if’ event model graphically and/or numerically illustrates the greater efficiencies and more streamlined operations that result from implementing the selected products and/or services. Accordingly, one benefit of this embodiment is that it can quickly and easily provide a visual description of the benefits that implementing a particular product and/or service can have to the operations of an airline or other major enterprise.

If the user wishes to select other products and/or services and view the effects of implementing them, the user can do so in decision block 218 by returning to block 214 and proceeding as described above. Alternatively, the user can proceed to block 220 and select various forms of comparative analyses and/or other forms of output that illustrate the operational impact and value of implementing the “what if” model. Such comparative analyses can include, for example, a comparison of the relative costs between the “as is” event model and the “what if” event model. Other forms of comparative analyses can include a graphical display of the percent increase in on time schedule performance for the airline that results from implementing the selected products and/or services. Yet other forms of comparative analyses can be selected by the user including cash flow analyses, etc. In addition to the foregoing, the user can also request various forms of output in the form of data reports, executive summaries, business cases, business proposals, etc. These and other aspects of the present invention are described in greater detail below with reference to the corresponding display pages.

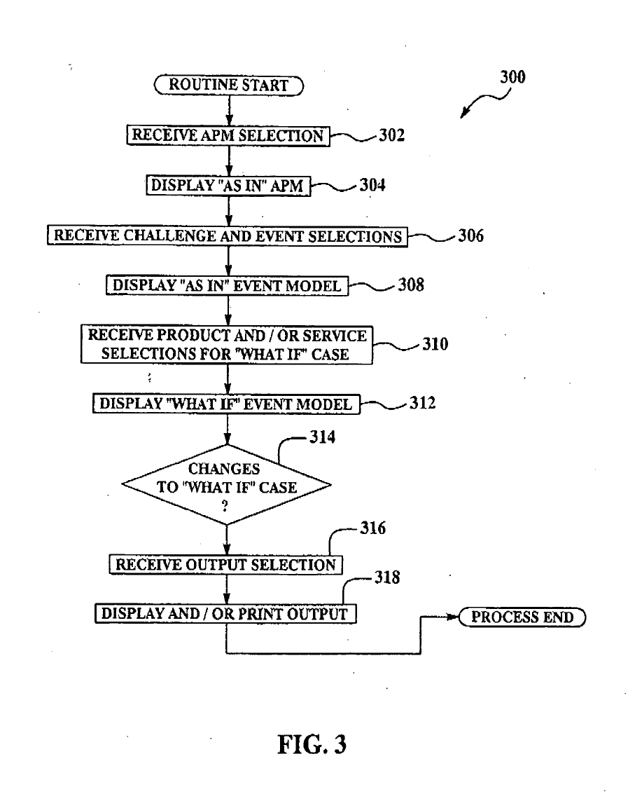

FIG. 3 is a flow diagram illustrating a routine 300 for displaying a “what if” event model and providing various forms of output relating to the event model in accordance with an embodiment of the invention. In one aspect of this embodiment, the routine 300 can be performed by one of the user computers 102 described above with reference to FIG. 1 in accordance with computer executable instructions stored on a corresponding computer-readable medium. In other embodiments, the routine 300 can be implemented by other computational devices.

The routine 300 begins in block 302 by receiving an “as is” APM selection from a user. As set forth above, in one embodiment, the “as is” APM is an organized collection of graphical and numerical data that describes the current functions, processes, information elements, and other parts of a particular airline.

In block 304, the routine 300 displays the “as is” APM in response to the selection. In block 306, the routine 300 receives challenge and event selections from the user. In block 308, the routine 300 displays an “as is” event model in response to receiving the challenge and event selections.

After displaying the “as is” event model, in block 310 the routine 300 can receive product and/or service selections from the user corresponding to a “what if” case. In response to receiving these selections, the routine 300 can display a corresponding “what if’ event model in block 312. In decision block 314, the routine 300 checks for any changes to the “what if’ case from the user. If there are any changes, the routine 300 returns to block 310 and updates the “what if” case to reflect the changes (e.g., additions and/or deletions of products and services).

In block 316, the routine 300 receives output selections from the user. As described in greater detail below, these output selections can include requests for various forms of textual and/or graphical output including cost comparisons, time comparisons, and other forms of analyses that compare the “as is” case to the “what if’ case. Such output can further include printouts of various reports such as executive summaries, business cases, and/or proposals. In block 318, the routine 300 displays and/or prints the requested output before ending.

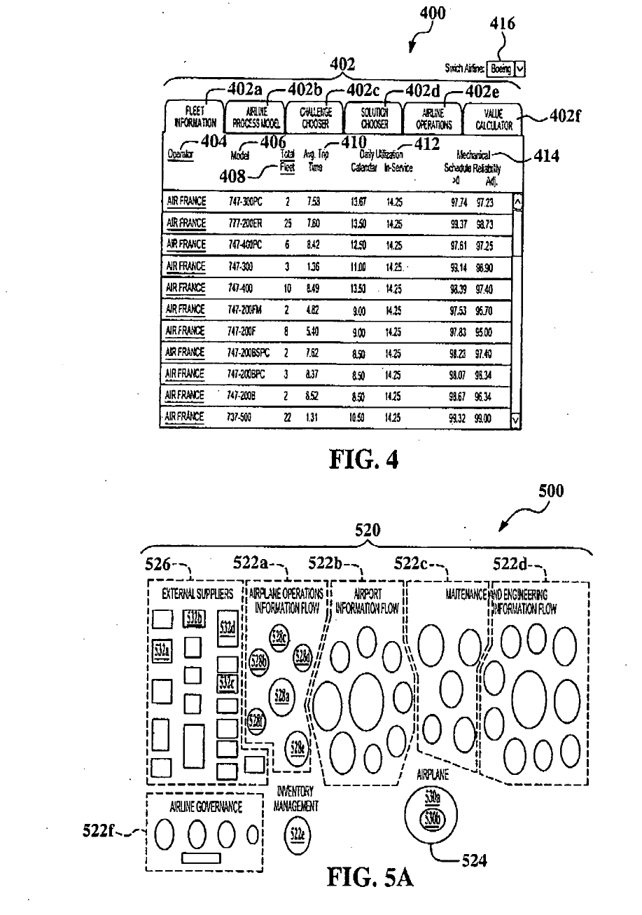

FIG. 4 is a schematic diagram of a display page 400 for presenting aircraft fleet information in accordance with an embodiment of the invention. The fleet information relates to the particular airline identified in a column 404. The information can include, for example, the particular aircraft models in the fleet, as identified in column 406, and the total number of each model, as shown in column 408. Further, the average trip time for each model can be shown in column 410, the daily utilization time can be shown in column 412, and the mechanical schedule reliability can be shown in column 414. The display page 400 can further include an airline drop down menu 416. The drop down menu 416 can include a list of the airlines from which the user can select. By selecting one of the listed airlines, the corresponding fleet information for that airline is displayed on a corresponding version of the display page 400.

In one aspect of this embodiment, the information presented on the display page 400 can be used to generate various portions of the “as is” and “what if” event case comparisons described in greater detail below. Although particular types of information are illustrated in FIG. 4 by way of example, in other embodiments, the display page 400 and extensions thereof can include other types of information. Like many of the display pages described below, the display page 400 can include a plurality of page tabs 402 (identified individually as page tabs 402a-f) arranged along an upper portion of the display page 400. By selecting one of the tabs 402, the user can bring up a corresponding display page containing the information and/or functionality identified by the tab. For example, the display page 500 discussed below with reference to FIG. 5A can be displayed in response to the user selecting the APM tab 402b.

FIG. 5A is a schematic diagram of a display page 500 illustrating an airline process model 520 (“APM” 520) configured in accordance with an embodiment of the invention, and FIGS. 5B-H present enlarged portions of the APM 520 in more detail than FIG. 5A. The APM 520 is an organized data structure that graphically illustrates the various processes performed by different functional groups in a selected airline. In the illustrated embodiment, the different functional groups are represented by circles and ellipses, and are divided among different functional areas. The different functional areas can include Airline Operations 522a, Airport Information 522b, Aircraft Maintenance and Engineering 522c, 522d, Inventory Management 522e, and Airline Governance 522f. In other embodiments, the APM 520 can include other functional areas.

By way of example, the Airline Operations functional area 522a can include functional groups responsible for Airline Operational Control 528a, Fleet Management 528b, Payload Control 528c, Market Development and Planning 528d, Flight Operations 528e, and In-flight Service 528f. Each of the foregoing functional groups 528 can perform a wide variety of different functions that are related to the overall function area. These individual functions are not listed in FIG. 5 because of size constraints. By way of example, however, the Airline Operational Control functional group 528a can perform functions related to flight scheduling, equipment scheduling, dispatch/flight operations, cabin crew tracking and scheduling, customer service, operation analysis, etc. The payload control functional group 528c can perform functions related to, for example, airline flight schedules, cargo sales, passenger sales, etc. The flight operations functional group 528e can perform functions related to, for example, flight crew rosters, navigational data and charts, fuel on board, airplane performance data, etc.

In addition to the functional areas described above, the APM 520 can further include an Airplane Functional area 524 and an external supplier functional area 526. The Airplane Functional area 524 includes an airplane functional group 530a and a crew kit functional group 530b. The external supplier functional area 526 includes a plurality of functional groups represented by squares. These functional groups can include entities outside the airline that influence the day-to-day operations of the airline in some way. For example, in the illustrated embodiment, the external supplier functional area 526 can include outside functional groups such as air traffic control 532a, fuel suppliers 532b, customs and immigration 532c, government security agencies 532d, etc. In other embodiments, the external supplier functional area 526 can include other functional groups.

The architecture of the APM 520 described above is but one example of an airline process model configured in accordance with the present invention. Accordingly, in other embodiments, other airline process models configured in accordance with the present invention can include other arrangements of functional areas and/or functional groups. Further, in such embodiments, the functional groups can include other processes in addition to, or in place of, the processes included in the APM 520.

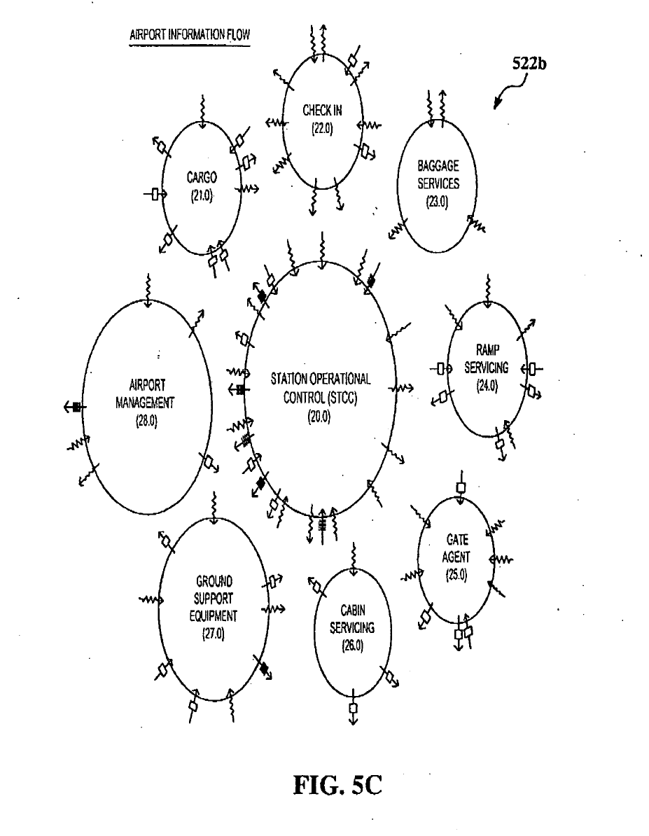

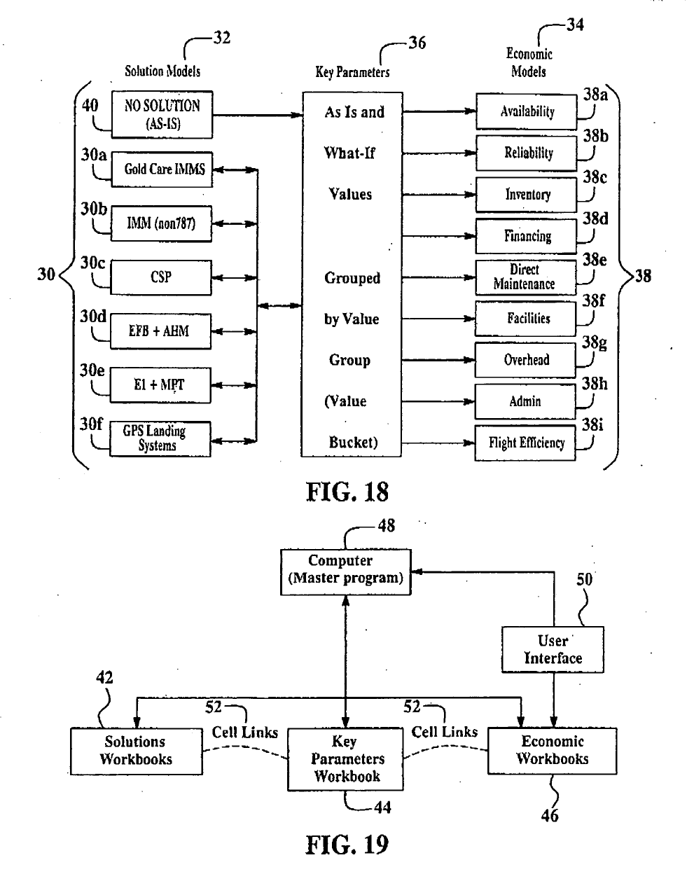

The foregoing description of the display page 500 provides a broad overview of the architecture of the APM 520. Additional details of the various functional areas included in the APM 520 are provided for reference in corresponding FIGS. 5B-51. Some of the symbols illustrated in FIGS. 5B-51 are described below with reference to FIG. 6.

FIG. 6 is a schematic diagram of a display page 600 illustrating an enlarged portion of the APM 520 of FIG. 5A. Specifically, the display page 600 illustrates the functional groups in the Aircraft Maintenance and Engineering functional area 522c that are responsible for Overnight Planning 634a, Airplane Line Maintenance 634b, and Maintenance Operational Control 634c. Each of the functional groups 634 includes a plurality of corresponding processes or functions. The Airplane Line Maintenance functional group 634b, for example, includes an Airplane Discrepancies function 636b and a request MEL (minimum equipment list) deferral function 636c. Further, the maintenance operational control functional group 634c includes, among others, an Airplane Discrepancies function 636a.

Each function in the different functional groups includes a function identifier 638. For example, the Airplane Discrepancies function 636b includes a first function identifier 638a (i.e., “61.1”). The function identifiers 638 are used to designate the destinations of various types of information (identified individually as information flows 640a-d) that flow between the different functional groups. Each individual information flow 640 has a particular graphical representation that represents the particular type of information that is exchanged. Referring to the Airplane Discrepancies function 636b, for example, the first information flow 640a is represented by a first line type (e.g., a jagged line) to illustrate that digital information is sent from the Airplane Discrepancies function 636b. Because the arrow on the jagged line points away from the Airplane Discrepancies function 636b, this indicates that the digital information is provided from the Airplane Discrepancies function 636b to the other functions identified by the second function identifiers 638b.

The broken line and the associated arrow of the second information flow 640b indicates that voice data is transmitted to the Airplane Discrepancies function 636b from the function having the identifier 31.6 (for reference, the function identifier 31.6 corresponds to a logbook entries function included in the crew kit functional group 530b illustrated in FIGS. 5A and 5G). The page symbol illustrated of the third information flow 640c indicates that paper copies of information are transmitted to the Airplane Discrepancies function 636b from the 31.6 function. Further, the broken line and the outwardly pointing arrow of the fourth information flow 640d indicates that the Airplane Discrepancies function 636b transmits voice data to the 60.1 function (i.e., the Airplane Discrepancies function 636a of the maintenance operational control functional group 634c).

As mentioned above, the APM 520 (FIG. 5A) can be used to graphically illustrate how the different functional groups respond to challenges and events that occur in the day-to-day operations of the airline. The following example illustrates one way the portion of the APM 520 shown in FIG. 6 can be used in this manner. In this example, an airplane discrepancy occurs and a line mechanic troubleshoots the discrepancy as part of the Airplane Discrepancies function 636b. The line mechanic then determines if an MEL deferral is the appropriate response in a Request MEL Deferral function 636c. Next, the line mechanic notifies the Airplane Discrepancy Function 636a via voice data that a discrepancy was reported. The MEL Deferral Release Number function 636d of the Maintenance Operational Control functional group 634c then sends the line mechanic an MEL deferral number via digital data. The line mechanic receives the digital data in a corresponding MEL Deferral Release Number function 636e of the Airplane Line Maintenance functional group 634. The line mechanic then walks the MEL deferral number to the airplane as paper data traveling from the MEL deferral release number function 636e to the log book entry function of the Crew Kit functional group 530b (FIG. 5G).

As the foregoing example illustrates, the APM embodiment described in FIG. 6 provides a useful graphical tool for visualizing the various processes that must be carried out by the airline to respond to a particular problem or event. As described in greater detail below, this feature of the APM can also be used to identify inefficient processes that can be improved by implementing various products and services. Further, this feature is also useful for visualizing and contrasting how the products and services, if implemented, can improve the existing “as is” processes.

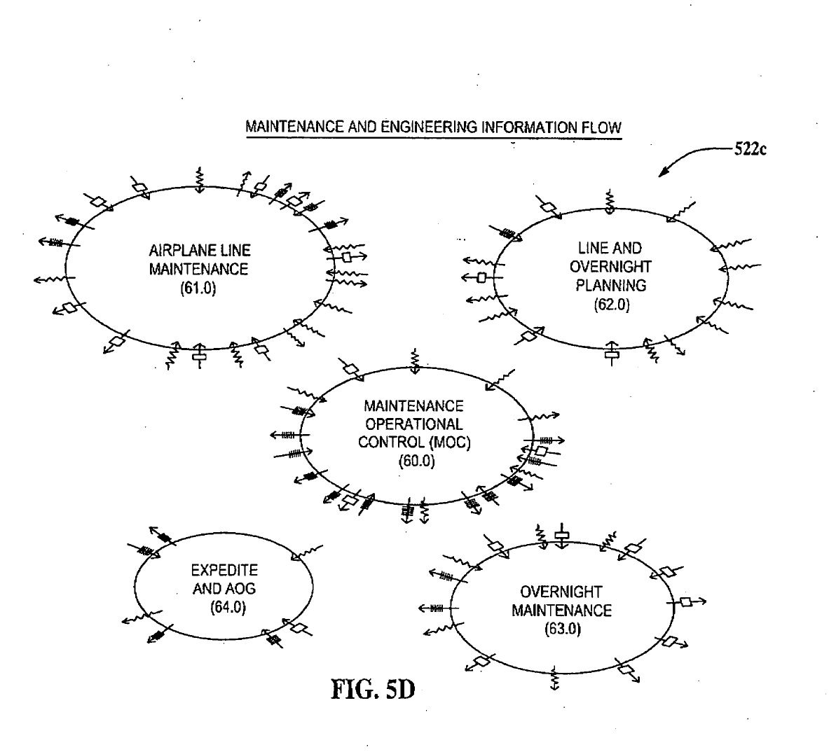

FIG. 7 is a schematic diagram of a display page 700 for selecting a “challenge” and an associated “event” in accordance with an embodiment of the invention. The display page 700 can include a challenge drop-down menu 762 and an event drop-down menu 764. The user can begin by selecting a challenge from the challenge drop-down menu 762. As explained above with reference to FIG. 2, a “challenge” is an operational problem facing the airline that is associated with one or more related “events.” Examples of challenges include “delays and cancellations,” “maintenance program compliance,” “crew productivity,” and “air traffic routing.” Next, the user can select an associated event from the event drop-down menu 764. An event is an airline operational circumstance to which the APM 520 (FIG. 5A) responds, such as “fuel quantity indicator failure.” After making these selections, the user can select an “as is” button 766 to bring up an “as is” event model that graphically illustrates how the relevant portion of the APM 520 responds to the selected event.

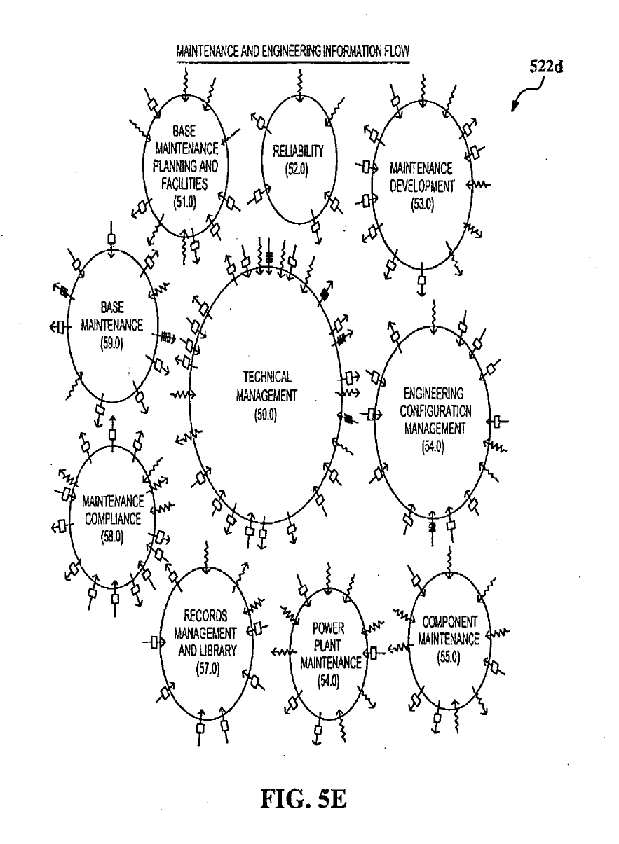

FIG. 8 is a schematic diagram of a display page 800 illustrating an “as is” event model 820 configured in accordance with an embodiment of the invention. The “as is” event model 820 graphically illustrates how the relevant functional groups in the APM 520 (FIG. 5A) respond to the fuel quantity indicator failure event selected via the display page 700 of FIG. 7. In the illustrated example, the relevant functional groups include the airplane functional group 530a, the Airline Operational Control functional group 528a, and a maintenance operational control functional group 828, among others. Each of these functional groups performs functions in response to the fuel quantity indicator failure. These individual functions are identified by numbers that correspond to the sequence in which the functions are performed. For example, the first step in response to the fuel quantity indicator failure (identified by the number 1) is performed by the Airplane functional group 530a when the pilot report is recorded (via voice transmission) in the log book; the second step (identified by number 2) is performed by the Airline Operational Control functional group 528a when the pilot reports the problem via another voice transmission; and so on from there.

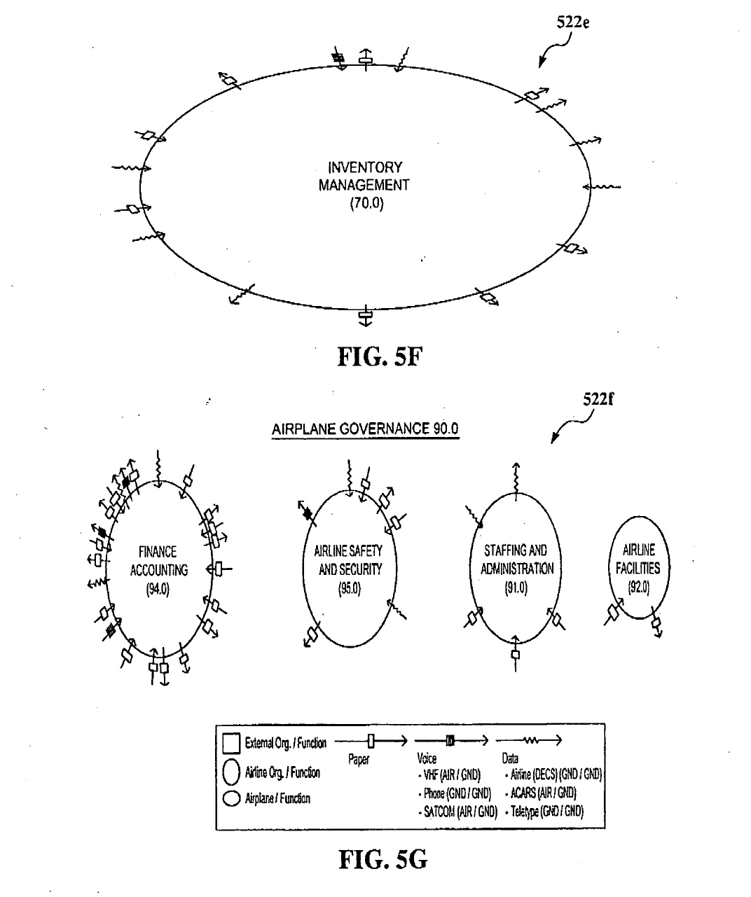

Each of the functional steps noted by a number in FIG. 8 includes attributes that describe the function performed. In one aspect of this embodiment, the user can review and/or edit these attributes with a display page 900 schematically illustrated in FIG. 9. In one embodiment, the user can bring up the display page 900 for a particular function by simply clicking on the number that corresponds to that function on the “as is” event model 820. Referring to FIG. 9, the display page 900 can include a number of data fields with which the user can alter the various attributes associated with the selected function. For example, the attributes display page 900 includes a name field 952 and an attribute description field 954. The attribute display page 900 also includes a movie feature 956 and a brochure feature 958. The movie feature 956 allows the user to view a movie describing aspects of the particular function. Similarly, the brochure feature 958 allows the user to view and/or order a hard copy of a brochure describing the particular function.

In addition to the foregoing, the attribute display page 900 also includes an input field 953, an output field 955, a work time field 957, and a cost field 959. The input field 953 displays the current set of functions that provide input to the selected function. Similarly, the output field 955 lists the current set of functions that receive output from the selected function. The work time field 957 shows the number of man-hours required to perform the function, and the cost field 959 shows the cost in dollars of performing the function. By editing the attribute display page 900, the user can automatically modify the corresponding airline process model as required to accurately reflect the actual processes performed by the airline.

Returning to FIG. 8, the “as is” event model 820 assumes that no new products or services have been implemented by the airline to facilitate the various operational processes and streamline how the airline responds to different challenges and events. As a result, one advantage of the “as is” event model 820 is that it allows the airline operator to easily see the inefficiencies that may exist in Airline Operations and the relative need for products and services that can streamline these operations. If the airline operator is interested in seeing how various products and services can improve the situation, the user can do so by returning to the display page 700 described above with reference to FIG. 7 and selecting a “what if” button 768 (see FIG. 7).

FIG. 10 is a schematic diagram of a display page 1000 for selecting a “what if’ case in accordance with an embodiment. The display page 1000 includes a list of products and services 1070 from which the user can select. The products and services 1070 can include various software and database programs that automate and/or partially automate various processes carried out by the airline functional groups. For example, EFB-electronic log book 1070a is an Internet enabled log book that allows pilots to enter information about each flight electronically. PMA 1070b is a portable maintenance aid (e.g., a laptop-like device) that aircraft mechanics can carry with them onto the airplane when conducting maintenance, repairs, etc. This tool allows them to electronically access drawings, maintenance instructions, task cards, etc. without needing to get off the airplane and find hard copies of the information. As a result, this product can greatly increase the efficiency of the mechanic.

After reviewing the different products and services 1070, the user can select the products he or she wishes to implement by checking the adjacent box. In addition, the user can also enter notes about the particular “what if’ case in a note field 1072. Once the user has selected the desired products and services and entered any relevant notes, the user can select a “create case” button 1073 to create a corresponding “what if” case.

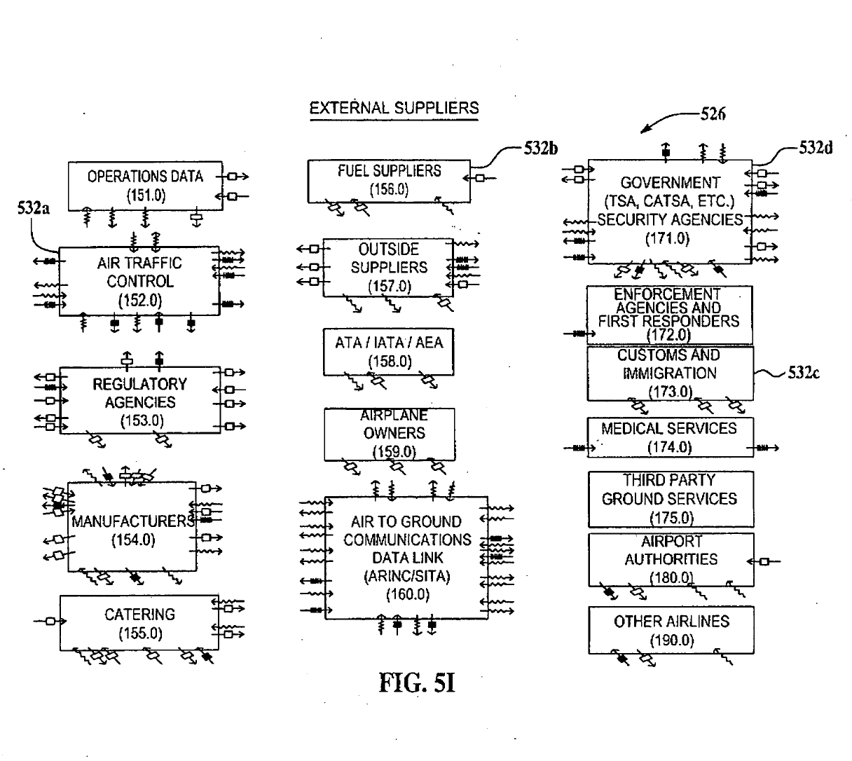

FIG. 11 is a schematic diagram of a display page 1100 listing options for the user after a “what if’ case has been created. The display page 1100 includes a case name field 1180 that identifies the particular “what if’ case, and a products field 1182 that lists the selected products that the user wishes to implement in the “what if” case. In addition, the display page 1100 further includes a plurality of options buttons 1184. The option buttons include, for example, a run case option 1184a, a calculate option 1186b, an edit option 1184c, a delete option 1184d, and a create option 1184e. In this embodiment, selecting the run case option 1184a brings up a display page that graphically illustrates a “what if’ event model that corresponds to the selected “what if’ case. Selecting the edit option 1184c enables the user to edit the selected “what if” case. Selecting the delete option 1184d enables the user to delete the particular case, and selecting the create option 1184e enables the user to create a new “what if’ case.

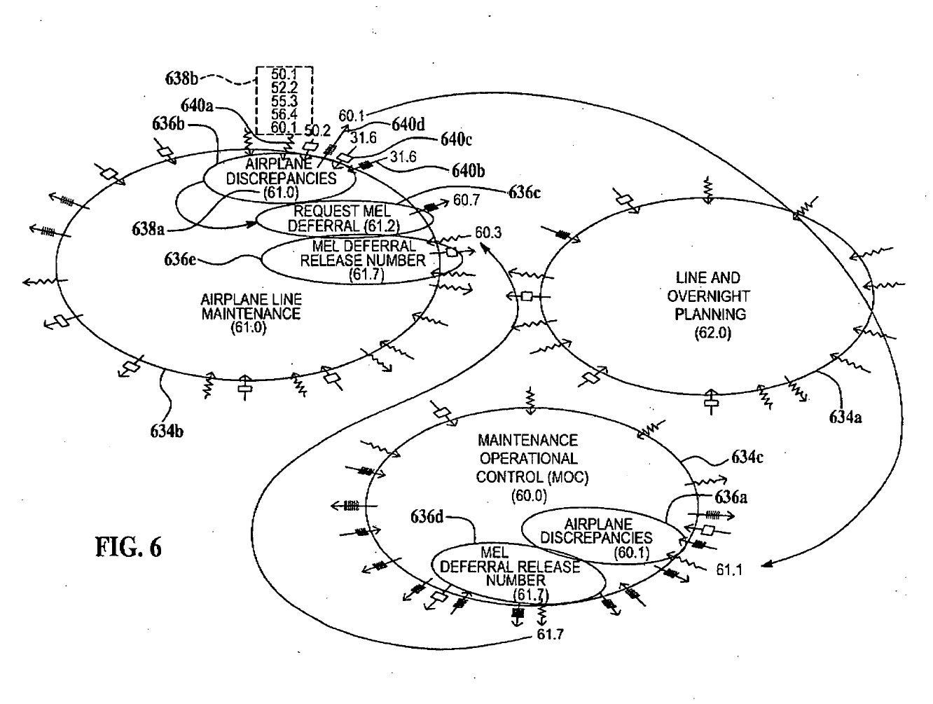

FIG. 12 is a schematic diagram of a display page 1200 graphically illustrating a “what if’ event model 1220 corresponding to the “what if’ case selected in FIG. 10. Comparing the “what if’ event model 1220 to the baseline “as is” event model 820 (FIG. 8) clearly illustrates that implementation of the selected products and services would greatly reduce the number of functional steps the airline takes to respond to the particular challenge and event selected in FIG. 7 (i.e., the fuel quantity indicator failure). Accordingly, this tool can provide a sales agent with a means for quickly and convincingly demonstrating the benefits of implementing the different products and services to a prospective airline.

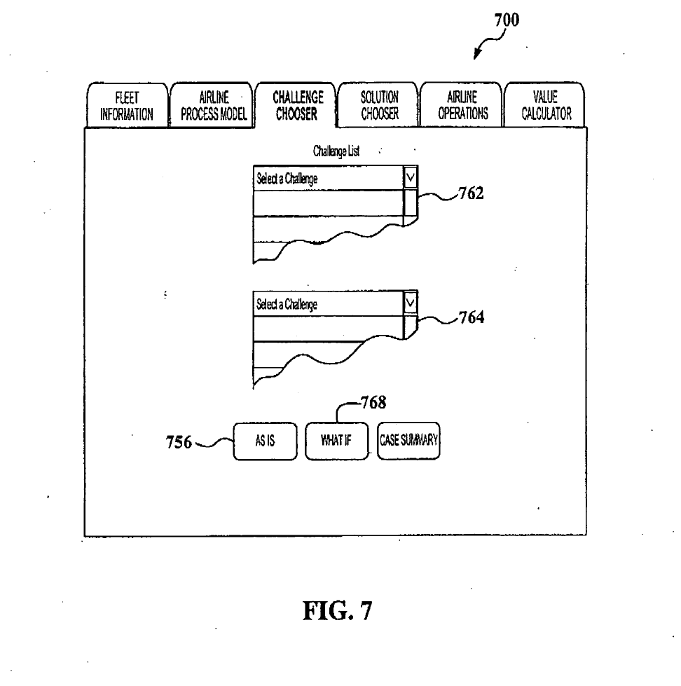

FIG. 13 is a schematic diagram of a display page 1300 that includes a list 1360 of existing “as is” and “what if” event cases configured in accordance with an embodiment of the invention. A case identifier for each case is provided in a case column 1302. User-entered notes for each case can also be provided under the corresponding case identifier. For “what if’ cases, the products selected by the user are listed in an adjacent product column 1304. In one embodiment, the display page 1300 can be used as a reference for selecting from previously-run event cases. If the user wishes to view an event model corresponding to a particular case, the user can do so by selecting an appropriate select button 1306.

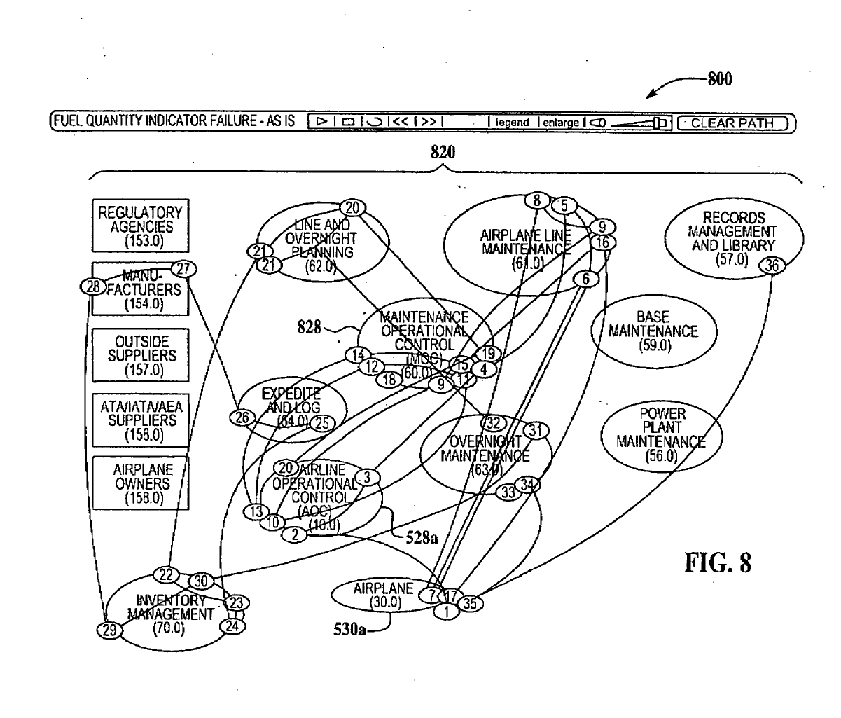

In addition to the graphical methods described above for comparing a “what if” event model that implements various products and services to an existing “as is” event model, the present invention also includes various methods and systems for presenting cost, schedule, and other data that illustrate the benefits of the selected products and services. For example, returning to FIG. 11, selecting the calc button 1184b can bring up a value calculator display page 1400 as schematically illustrated in FIG. 14.

Referring to FIG. 14, the display page 1400 can include a number of spreadsheet fields 1470 (identified individually as spreadsheet fields 1470a-c) that compare costs associated with an “as is” model to costs associated with a corresponding “what if’ model. For example, the model delay cost field 1470a can compare the costs of various delays in the “as is” model to the costs of delays in the “what if’ model for different aircraft types. The fleet value field 1470b includes similar data corresponding to the annual value, the annual cost, the net value and the benefit cost/ratio for the delays. The fleet profitability field 1470c includes data that compares the year-by-year cost to the customer of the selected solutions (i.e., the selected products and services) vs. the year-by-year savings from implementing the solutions. As those of ordinary skill in the art will appreciate, the forgoing spreadsheets are merely representative of the various types of tools that can be included with the present invention to facilitate the comparison and/or analysis of the different product and/or services.

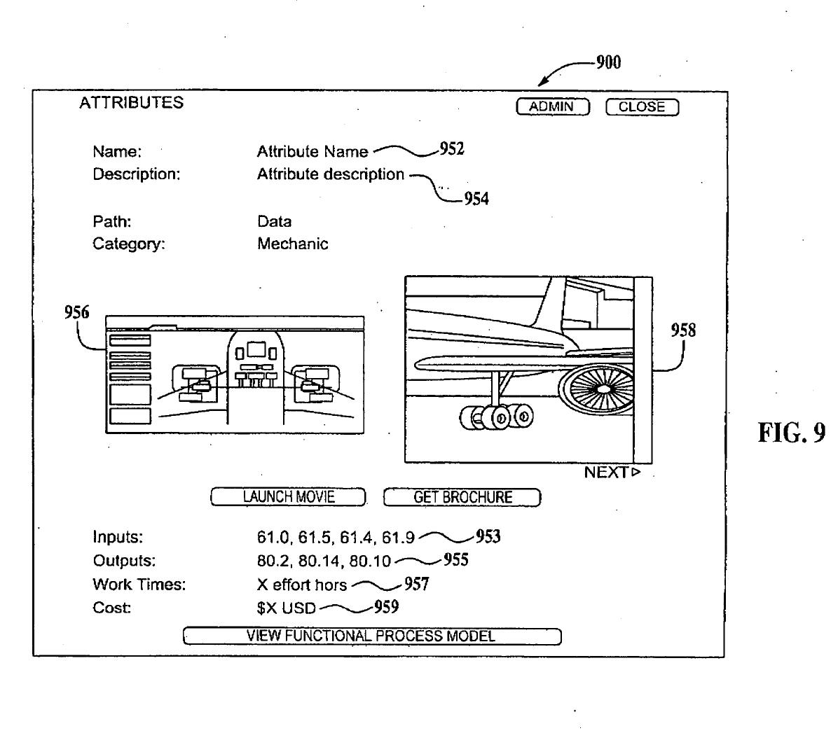

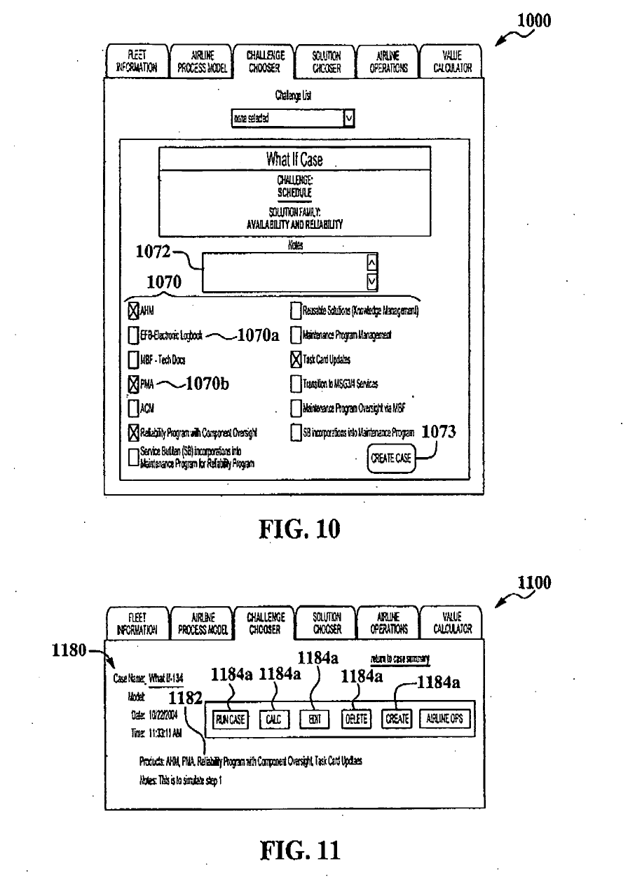

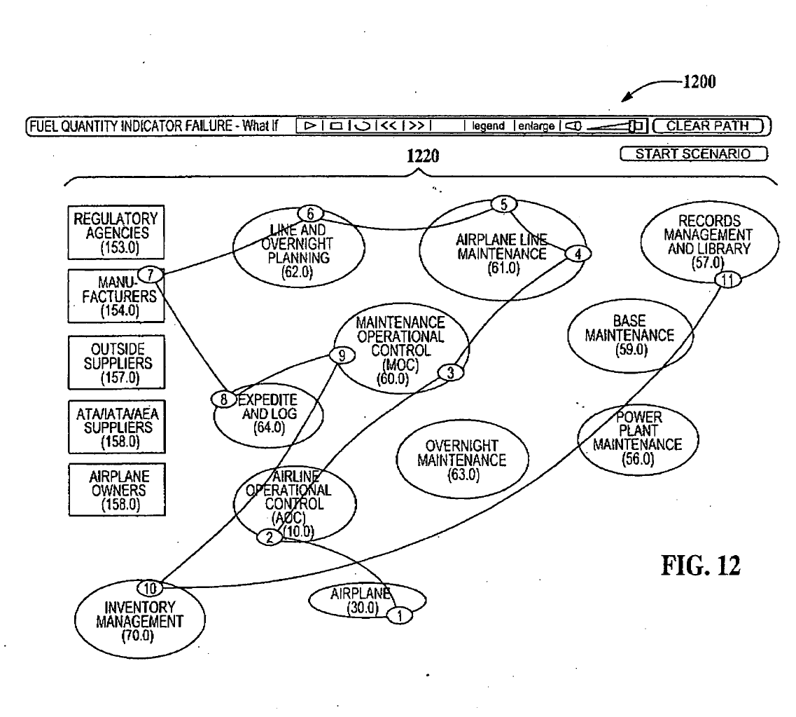

In addition to the spreadsheet fields 1470 described above, the display page 1400 can also include a number of page selectors that can take the user to other forms of output related to the selected products and services. For example, by selecting a proposal button 1418, the user can request a print out of a products and services proposal to give the prospective customer. By selecting a business case button 1420, various portions of the relevant data described above can be assembled into a report with associated value analyses that can be printed out for the customer. Similarly, by selecting an executive summary button 1422, the user can request additional spreadsheet data, such as that illustrated in the display page 1500 of FIG. 15 which graphically describes the results of comparative analyses between the “as is” case and the “what if” case. The executive summary can additionally include spreadsheet data, such as that illustrated in a display page 1600 of FIG. 16, which allows the user to “scale-up” the benefits associated with the selected products and services for various portions of the current airline fleet and for future fleet growth. The executive summary can further provide graphical data and schedule performance data, such as that illustrated in a display page 1700 of FIG. 17.

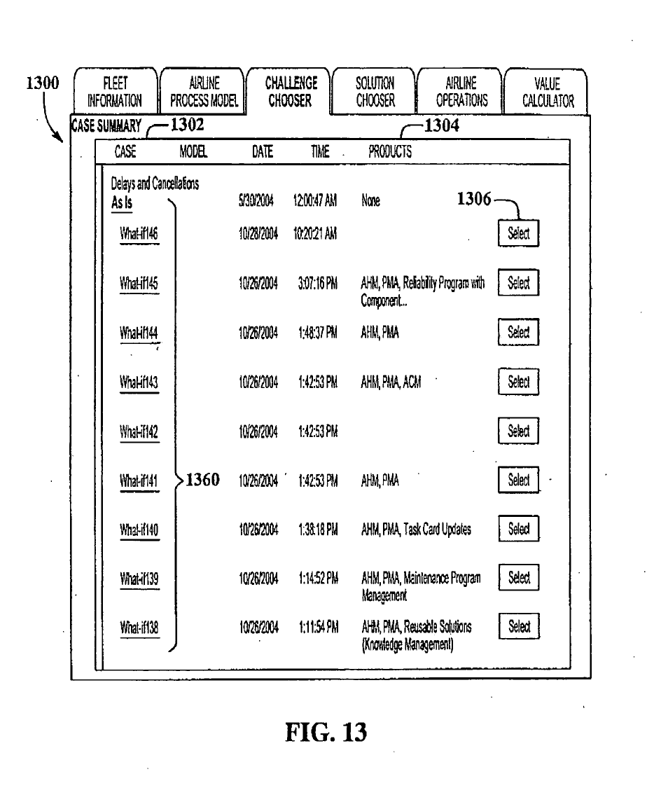

Referring now to FIG. 18, spreadsheets may be conveniently used to mathematically model the many-to-many relationships that exist between proposed service or product solutions and value categories that are deemed important by a customer. As used herein, “solutions” refer to products or services that potentially improve the operations of an enterprise and therefore result in direct or indirect economic benefit to the customer. As shown in FIG. 18, a plurality of possible solutions 30 form solution models 32. The solution models 32 are linked to economic models 34 by a set of key parameters 36. The economic models 34 comprise a series of value categories 38 which represent areas of a customer's operations in which the solutions 30 may provide potential economic benefit.

In the illustrated embodiment, the invention will be described in connection with commercial airline operations, however it should be noted that the invention may be advantageously used in any enterprise operations where it is desired to determine the economic benefit of each of a plurality of solutions in multiple value categories. As will be discussed later in more detail, the solution model 32 is linked to the economic model 34 by a set of key parameters 36. The key parameters 36 comprise a set of “as is” values and a set of “what if” values that are grouped according to the value categories 38.

In the illustrated embodiment, the solution model 32 includes a series of products offered by the Boeing Company that are useful in improving the operations of commercial airlines. These solutions comprise an integrated maintenance and materials service 30a, integrated materials management 30b, component services program 30c, electronic flight book and aircraft health maintenance 30d, the maintenance performance toolbox 30e and GPS landing systems 30f.

In the context of commercial airline operations, the value categories 38 forming the economic model 34 may include, by way of example, aircraft availability 38a, aircraft reliability 38b, aircraft inventory 38c, aircraft financing 38d, direct maintenance costs 38e, facility costs 38f, operating overhead 38g, administration costs 38h and flight efficiency 38i.

Since the key parameters 36 include both “as is” and “what if” values, the solution model 32 includes a category of “no solution” 38 which comprises “as is” values for key operating parameters that are loaded into the key parameters 36 as will be discussed below.

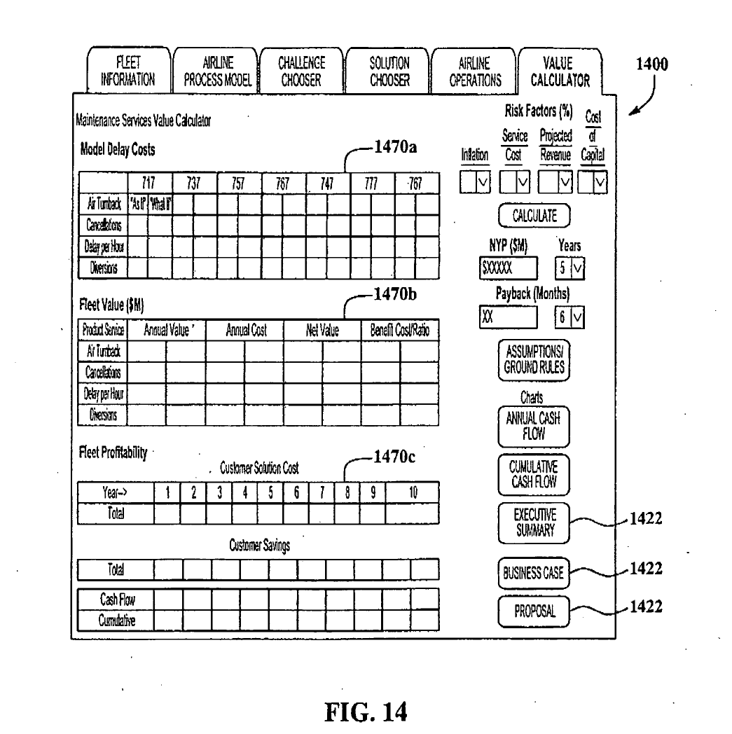

Referring now also to FIG. 19, the multiple proposed solutions 30 are evaluated by using three sets of software spreadsheet workbooks, comprising solution workbooks 42, a key parameter workbook 44 and economic workbooks 46. Each of the notebooks 42-46 comprises a series of worksheets having cells that are linked at 52 such that a change in a value in one cell of a spreadsheet results in a corresponding change in that same value in the cells of the other spreadsheets. The information contained in the workbooks 42-46 is accessed by a computer 48 operated by a master program that performs certain of the necessary calculations as will be described in more detail below. A user may input values, make selections and request certain types of reports and information using a user interface 50 which is accessed in the economic workbook 46. The exact nature of the master program used to program the computer 48 will vary depending upon the specific application and the types of analyses' to be performed. Generally however, as mentioned above, the computer 48 aids in populating the workbooks 42-46 with data, and generates various displays such as graphical presentations to aid the user in understanding the information presented. It should be noted here however, that all of the calculations are carried out directly within the workbooks 42-46, since most spreadsheet software such as the well known Excel spreadsheet program offered by Microsoft Corporation have fields within each spreadsheet that may be programmed by a user to perform a variety of calculations. As is well known, spreadsheets use rows and columns for entering numerical data and allow the user to enter formulas in the spreadsheets that are used to automatically calculate values based on the data contained in the cells formed by the rows and columns. The master program 48 translates the information contained in the worksheets into user interface screen displays that are user friendly.

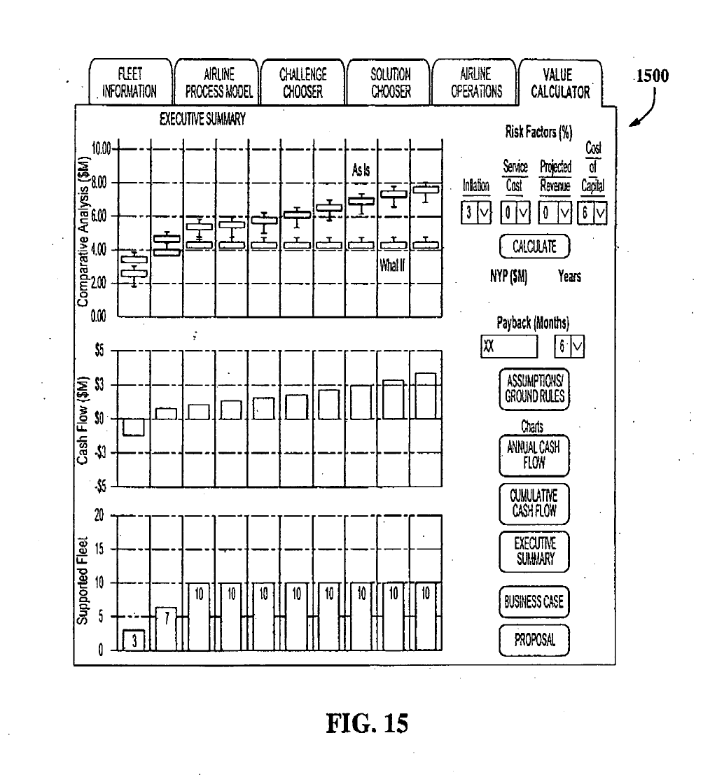

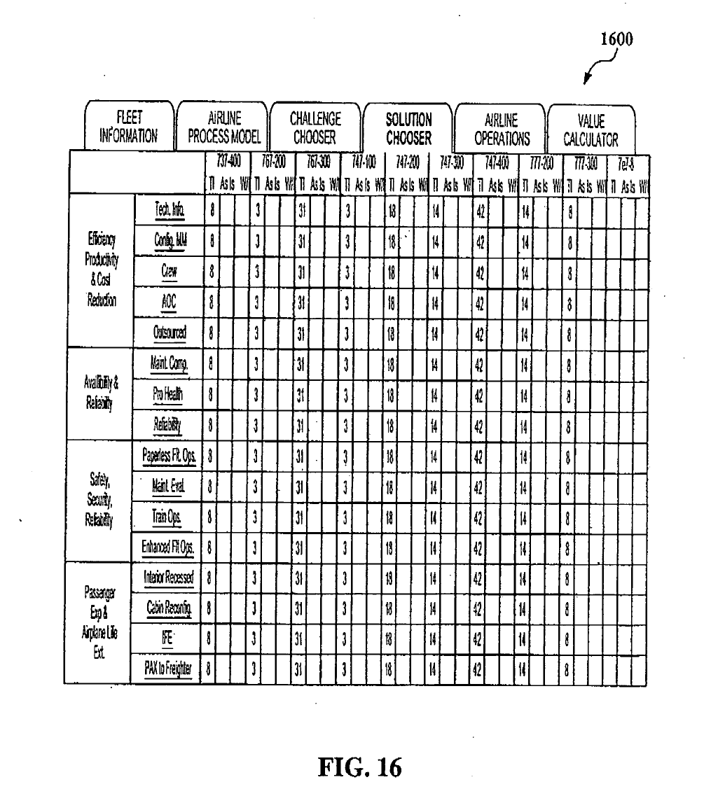

Referring now also to FIGS. 20-28, each of the workbooks 42-46 comprises a series of spreadsheets, also referred to as worksheets, including interface spreadsheets 54. For example, FIG. 21 displays a computer screen of the key parameters workbook 44 in which the interface sheet 54 is displayed. A first column lists the ID number 56 of each key parameter, followed in the next column containing the name 58 of the key parameter. Continuing, the next column 60 contains the “as is” value of the key parameter and column 62 contains the “what if” value of the same key parameter. Thus, each of the interface sheets 54 contains the ID, name and “as is” and “what if” values for each of a number of key parameters which collectively define a model or operating profile of the customer's enterprise operations. As shown in FIG. 21, the key parameters workbook 44 includes a series of additional spreadsheets identified by the tabs “what ifs for solutions” 64, “analysis” 66, “operating profiles” 68, “interpolate” 70 and “operating profile” 71. In the present example, each of the solutions 30 is contained in a separate workbook, however, it is possible, if desired, to place a plurality of the solutions in a single workbook.

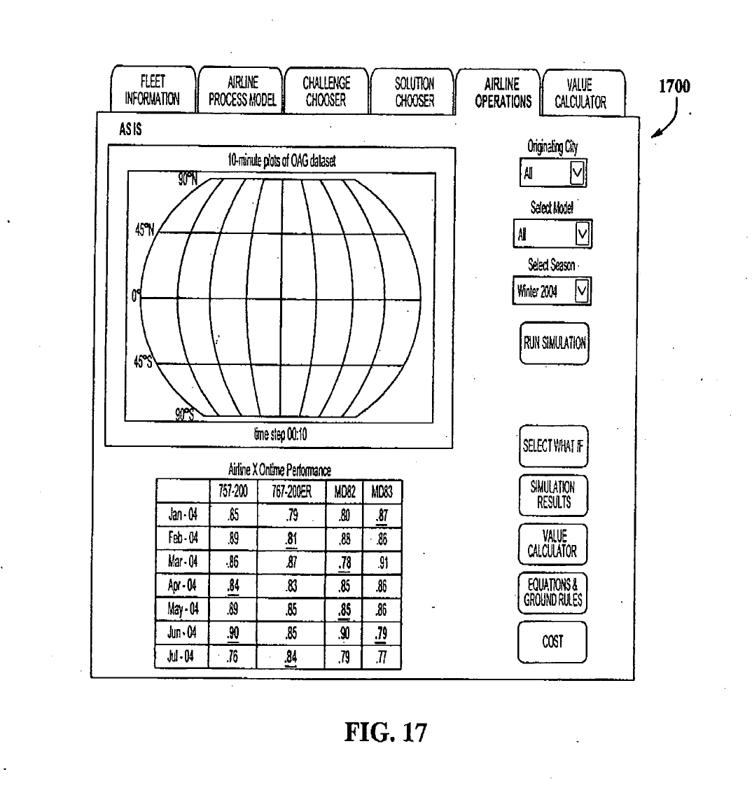

The interface spreadsheet 54 for the solutions notebook 42 is shown in FIG. 22, wherein it can be seen that the identical information describing the key parameters is displayed, consisting of the key parameter ID 56, name 58 and the “as is” and “what if” values 60, 62, respectively. Other spreadsheets contained in the solutions workbook 42 are identified by their tab names “inventory reduction” 72, “interpolate” 74 and “transformation matrix” 76.

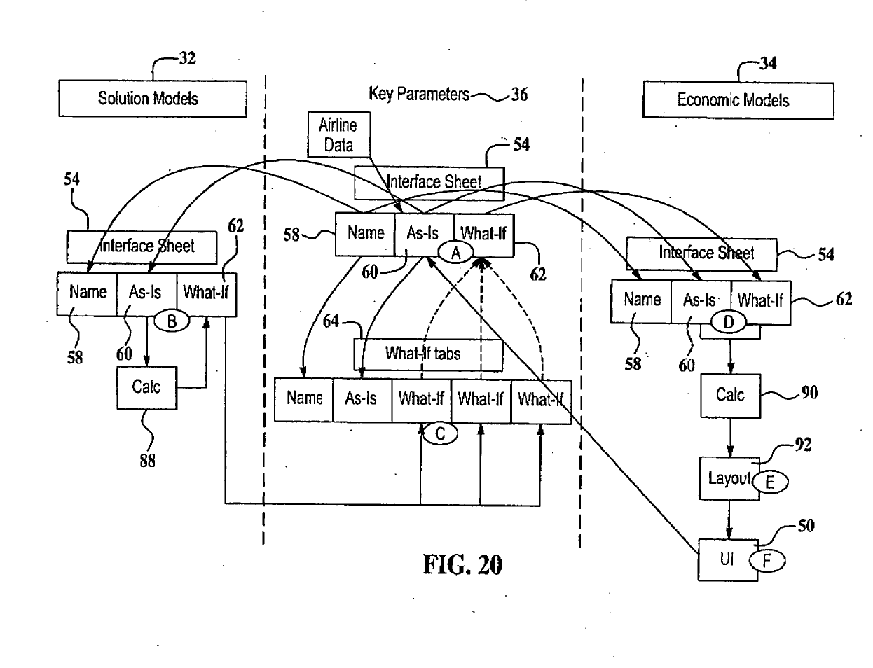

Similarly, as shown in FIG. 24, the interface spreadsheet 54 of the economic workbook 46 contains the key parameter ID 56 followed by the name 58 and the “as is” and “what if” values 60, 62, respectively. Other spreadsheets contained in the economic workbook 46 are designated by the tabs “layout operational” 78, “layout economic” 80, “GSE calculations” 82, “inventory” 84, and “interpolate” 86. The layout worksheets 78-80 in the economic workbook 46 are formatted in a manner such that they can be read by the master program in the computer 48 and portrayed on a computer screen as user interfaces. Certain cells in the spreadsheets that define the user interfaces are devoted to ground rules which the user can modify by typing in new values. Initially, the “as is” values for the key parameters used to populate the spreadsheets which appear in the user interface worksheets 54 define a particular operating profile of the customer's enterprise. For example, in the case of commercial airline operations, a particular operator profile might characterize a fleet of aircraft operating on long haul operations from North America to Asia. Another operating profile with a different set of key parameters would be chosen for short haul flights within North America between hub cities. After loading in a set of “as is” key parameter values for a particular operator profile, the user has the option of modifying certain of the key parameters, and these modifiable key parameters will be referred to herein as “ground rules”. Thus, the user may tailor the initial operator profile by altering the ground rules, thereby providing additional flexibility in analyzing a wider variety of “what if” scenarios. It should be noted here that although in the present example, each of the economic models 34 is in contained in separate workbooks 46, all of the economic models 34 could be contained in a single workbook, if desired.

A brief example will now be discussed in order to more fully describe the use of the workbooks 42-46 to calculate the “what if” values and determine the economic benefit of each of the solutions 30 in each of the valued categories 38. Following a discussion of this example, a more detailed explanation will be provided of the steps for carrying out the method of the present invention.

Referring now particularly to FIG. 20, as previously noted, the initial “as is” key parameters are determined by a selected operator profile normally chosen by the customer. Thus, many of the initial “as is” values for the key parameters are set by default, and only those key parameters that are allowed to be edited by the user may be modified to tailor the default operator profile. In the illustrated example, the interface spreadsheet 54 includes 420 key parameters whose values are shown in two columns divided into “as is” 60 and “what if” 62 values. For purposes of simplicity, only a portion of these key parameters are shown in the spreadsheets depicted in the drawings. As previously noted, the function of the solution model 32 is to read all of the “as is” values 60 and for a particular chosen solution 38, and calculate the “what if” values 62. For example, in the case of the key parameter “maintenance reliability” if the “as is” value is 98%, a particular one of the solutions 30 may result in a “what if” value for maintenance reliability of 99%, whereas a different solution may result in “what if” values that are only 98.5%.

As shown by the letter “A” in FIG. 20, after the default “as is” values for a particular operator profile have been loaded into the workbooks 42-46, the user may modify the ground rules by changing the values of certain “as is” key parameters 60 in the interface 54 spreadsheet of the key parameters workbook 44. Then, as shown by the letter “B”, the master program 48 selects one of solutions 30 to be evaluated, and populates the corresponding column of the key parameters workbook 44, enabling the value of the selected solution 30 to be calculated. In the illustrated example, the GoldCare IMMS product 30 (FIG. 18) is selected. Upon selection of this solution, the “what if” values 62 are automatically calculated at 88 and the calculated values are entered into the “what if” column 62 in the solutions workbook 42 for the selected gold care solution. Then, as shown by the letter “C”, the master program controlling computer 48 copies the “what if” values 62 in the solutions workbook and writes these values into the “what if” column 62 in the interface sheet 54 of the key parameters workbook 44. The dotted lines shown in FIG. 20 represent the selection of the appropriate “what if” values based on the GoldCare IMMS solution selected by the customer. In the event that the selected solution does not have an impact on a particular key parameter, then the calculated “what if” value will be the same as the “as is” value.

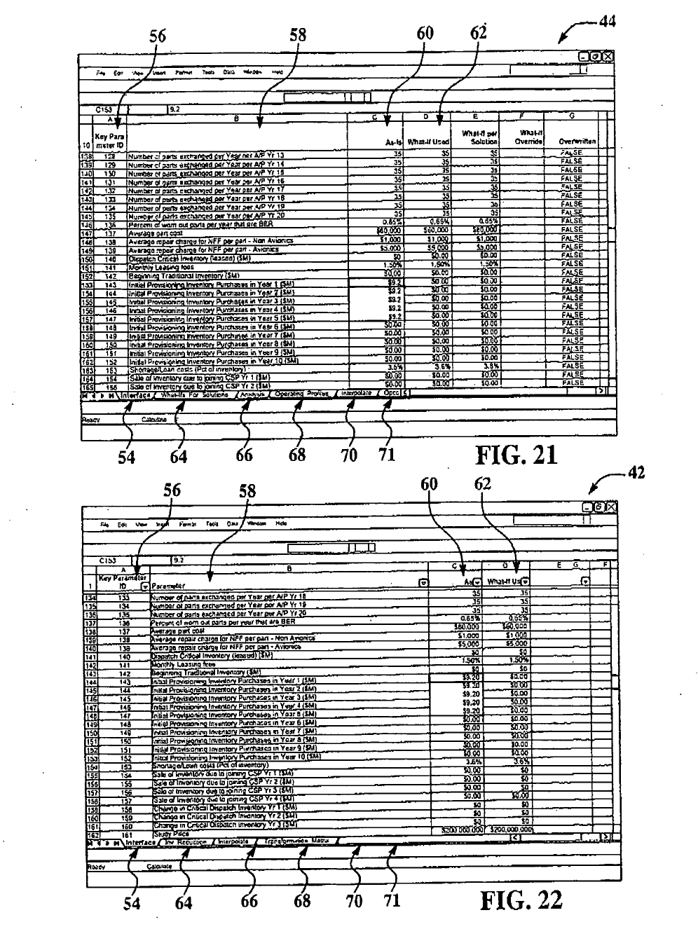

Next as shown by letter “D” in FIG. 20, the economic workbook 46 reads the “as is” and “what if” values from the interface sheet 54 of the key parameters workbook 44, and depending upon the value category 38 in the economic model 34 that has been chosen, and providing the “as is” and “what if” values are different, the economic value for that difference between the “as is” and “what if” values is calculated at 90. Thus, for example, if the difference between the “as is” and “what if” values for maintenance reliability 38b (FIG. 18) is 1%, then the computer 48 performs a set of calculations based on airline operating costs (tailored by the user's edited ground rules) and generates a number representing the dollar value of the 1% improvement in maintenance reliability. This economic result is displayed in the layout pages 92 in the economic workbook 46, as shown by the letter “E”. A typical example of a layout page 92 is shown in FIG. 25, where the operational layout 74 is depicted in spreadsheet format. The computer 48 functions to translate values in workbooks 42-46 into the user interface 50 shown by the letter “F” which displays both calculated values and reads ground rule edits by the user.

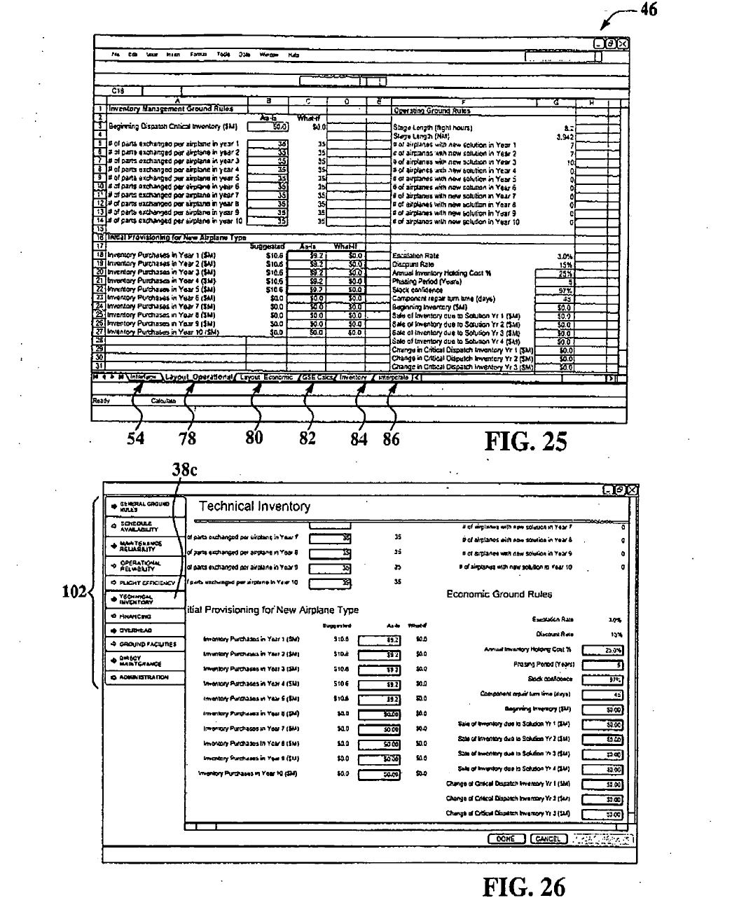

It should be noted here that when a user edits a field using the user interface 50, the computer 48 reads the edit and copies it into the key parameters columns of the workbooks 42-46, and the solutions workbook 42 then reads the edited values and calculates “what if” values if applicable. Then, the key parameters workbook 44 reads the calculated values, as does the interface sheet 54 of the economic workbook 46, resulting in the display of graphics information representing the results of economic calculation. FIG. 27 is a computer screen display of the economic layout of the spreadsheet 80 forming part of the economic workbook 46. As can be seen in FIG. 27, the economic benefits of a selected solution as they impact the cost of inventory are graphically depicted at 96. For convenience, operating ground rules 98 and economic ground rules 100 are shown on this same spreadsheet so that the user can clearly see the quantitative benefit of the solution based on the edits to the ground rules.

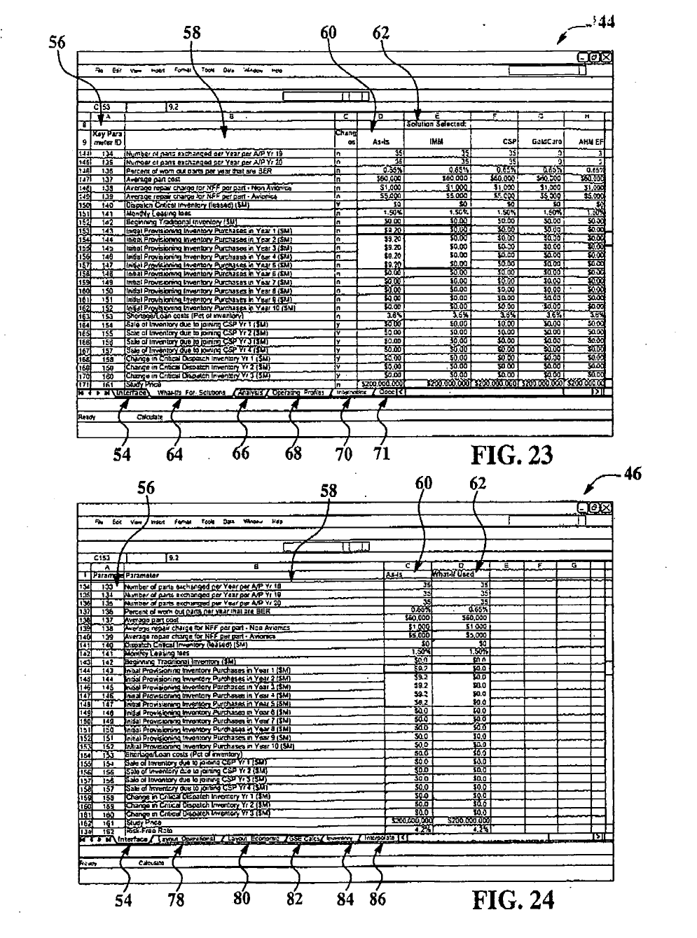

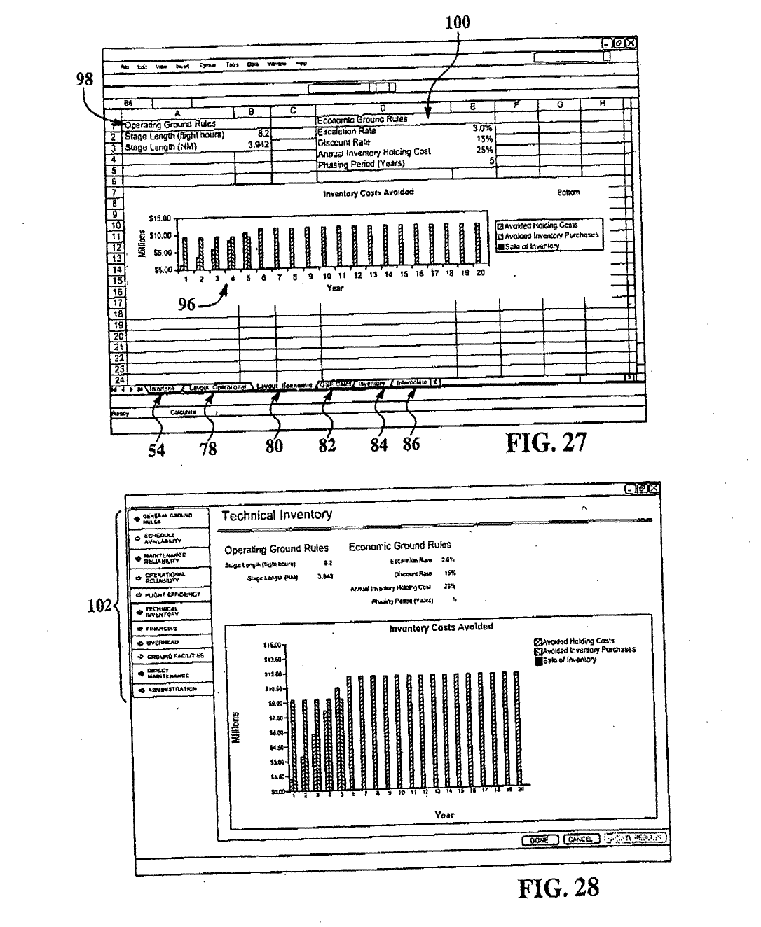

FIGS. 26 and 28 are computer screen displays forming part of the user interface 50. The screen display in FIG. 26 is a translation into a different format of the information contained in the worksheet shown in FIG. 25. Similarly, the screen display shown in FIG. 28 is a translation of the information contained in the worksheet shown in FIG. 27. These information display translations are performed by the master program 50. As seen on the left hand side of these screen displays, a menu 102 is provided that allows the user to select several different interface screens which include the value categories 38 as well as the general ground rules. In FIG. 26, the calculated benefits of a particular solution are shown in numerical form for the value category “technical inventory” 38c. Additionally, the economic ground rules are shown along with the “as is” and “what if” values forming the basis for the calculated economic values. FIG. 28 is similar to the screen shown in FIG. 26 but depicts the calculated economic values in graphical form.

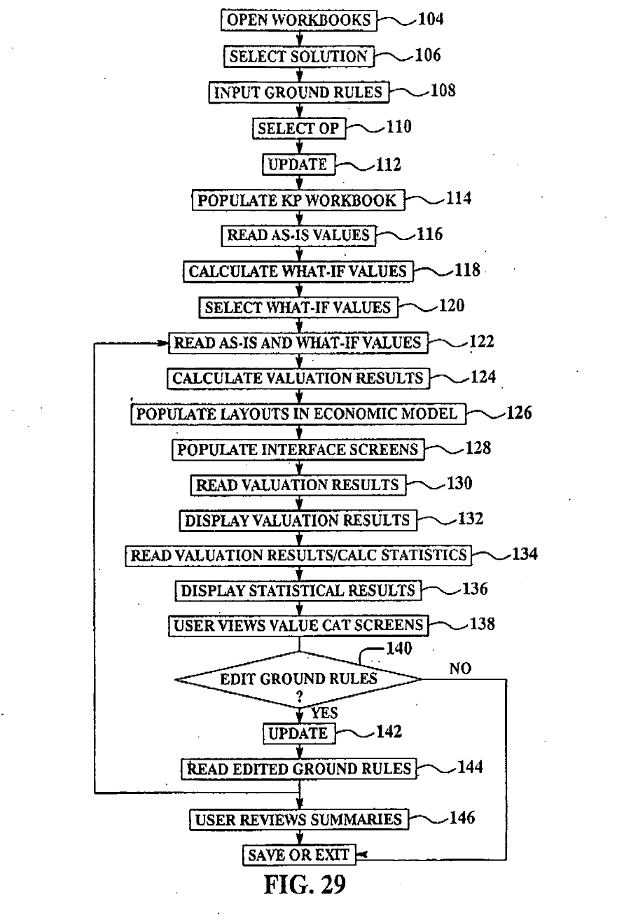

Attention is now directed to FIG. 29 which shows a detailed flow diagram of the method for valuing multiple solutions in multiple value categories according to the present invention. At step 104, the user opens the master program 48 which in turn opens the spreadsheets in all of the workbooks 42-46. Next, at 106, the user selects a target airline, initiates a study and selects a solution to be evaluated. Then, at step 108, the user inputs the ground rules for the current study such as, by way of example, the number of years, stage length in nautical miles and the cost of capital. At step 110, the user goes to the fleet information function found in user interface 50 in one of the spreadsheets and selects an aircraft model for the target fleet as well as the operating profile, and inputs the number of aircraft by year that the solution will be applied to. Next at step 112, the user clicks an update button on the screen display which results in the computer 48 updating the spreadsheets in all the workbooks 42-46. At step 114, the computer populates the key parameters workbook 44, and particularly the “as is” column values in the interface sheets 54, with initial values for the key parameters. Many of these values are drawn from the operator profiles. At step 116, the economic workbook 46 reads the “as is” values from the key parameters interface worksheet 54 and writes these values into the interface worksheet 54 in the solution workbook 42 for each solution 38.

At step 118, the value categories 38 in the economic model 34 use the “as is” key parameters to calculate the “what if” values for key parameters in those cases where the selected solution adds value. A complete set of “what if” values is written into the “what ifs for solutions” worksheet 64 of the key parameters workbook 44. For key parameters where the selected solution does not add value, the “what if” values remain the same as the “as is” values. At step 120, the master program in the computer 48 selects a set of “what if” values from the “what ifs for solutions” worksheet 64 of the key parameters workbook 44 and inserts them into the “what if” column 62 of the interface worksheet 54 in the key parameters workbooks 44. At step 122, the economic workbook 46 reads, for each of the value categories 38, the “as is” and “what if” values of the key parameters interface worksheet, through their own interface worksheets 54.

At step 124, the economic workbook 46 calculates the valuation results for the selected solution using the “as is” and “what if” values in their interface worksheets 54. At step 126, the economic workbook 46 populates these values into the operational layout and economic layout worksheets, 78, 80 respectively for each of the value categories 38. At 128, the master program 48 populates the user interface screens 50 using the data and formats in the operation layout and economic layout worksheets 78, 80. The operational layouts are displayed in the solution function of the master program 48 and the economic layouts are displayed in the valuation function. At step 130, the valuation summary economic worksheet reads the total valuation results for each of the value categories 38, calculates desired statistics based on the total, and displays them in a corresponding economic layout worksheet 80, which the master program 48 then displays to the user in the interface 50.

At step 132, the master program 48 displays the results in the economic summary screen forming part of the user interface 50. Next, at step 134 the valuation summary financial workbook reads the total valuation results, by year, from the summary economic workbook and calculates cash flow statistics by year calculates financial summary statistics and displays this information in a corresponding economic layout worksheet 80. At step 136, the master program 48 displays the results immediately discussed above in the financial summary screen forming part of the user interface 50.

Next, at step 138, the user looks up the value category screens within the solution and valuation functions, and the economic and financial summary within valuation. The user may then view the data from the spreadsheet layouts as they are displayed by the master program 48. As shown at step 140, if the user wishes to more realistically model the target airline, the displayed ground rules are edited in the solution and valuation screens, but if no edits are desired then the process ends at 148.

If, however, the ground rules are edited at step 140, then the user clicks on the update button at 142. The master program 48 then reads the new values at 144 that were edited by the user and copies these new values into the “as is” column of the interface worksheet in the key parameters workbook 44. The process returns to step 122 and the process of calculating the economic value of the solution for each value category 38 is repeated. As shown at step 146, the user may, at any time, view the economic summary or financial summary within the valuation function which are part of the summary results that are issued in a final study report. When satisfied with the results, the user can save the study, produce reports or exit the program at 148.

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Further, while advantages associated with certain embodiments of the invention have been described in the context of those embodiments, other embodiments may also exhibit such advantages, and no embodiment need necessarily exhibit such advantages to fall within the scope of the invention. Accordingly, the invention is not limited, except as by the appended claims.

What is claimed is:

1. A method for determining the value of products or services representing solutions for improving enterprise operations, comprising the steps of:
(A) populating a set of computer spreadsheets with key parameters representing a model of enterprise operations;
(B) linking the spreadsheets, such that a change in one of the spreadsheets results in corresponding changes in the other spreadsheets;
(C) selecting a solution for improving the enterprise operations;
(D) calculating the benefit of the solution in at least one of a plurality of value categories using the key parameters; and,
(E) displaying a set of data in the spreadsheets representing the benefit calculated in step (D).

2. The method of claim 1, further comprising the step of:
(F) altering the values of at least certain of the key parameters in the spreadsheets to reflect a variation of the model.

3. The method of claim 1, further comprising the steps of:
(F) providing a plurality of sets of enterprise operating data respectively representing differing enterprise operating profiles;
(G) selecting one of the operating data sets; and,
(H) using the data set selected in step (G) as at least part of the key parameters used to populate the spreadsheets in step (A).

4. The method of claim 1, wherein step (A) includes entering first and second sets of operating data into the spreadsheets, the first set of data representing enterprise operating characteristics without use of the selected solution selected in step (B), and the second set of data representing enterprise operating characteristics with use of the selected solution.

5. The method of claim 1, wherein step (D) includes calculating the total economic benefit of the solution for all the value categories.

6. The method of claim 1, wherein the model represents an operating profile of a commercial airline operation.

7. The method of claim 1, wherein step (B) includes using the key parameters to link a plurality of solutions for improving the enterprise operations to the plurality of value categories.

8. The method of claim 1, further comprising the steps of:
(F) providing a plurality of solutions for improving the enterprise operations;
(G) calculating improvements in the key parameters resulting from use of each of the solutions in the enterprise operations; and,
(H) populating the spreadsheets with data representing the improvements calculated in step (G).

9. A method for evaluating products or services representing solutions for improving enterprise operations, comprising the steps of:
(A) selecting a solution;
(B) selecting an operating profile for the enterprise operations;
(C) populating a set of computer software spreadsheets with “as is” key parameters representing a model of the enterprise operations without use of the selected solution;
(D) calculating a set of “what if” key parameters representing the model of the enterprise operations if the selected solution is used;
(E) populating the spreadsheets with the “what if” key parameters; and,
(F) calculating the benefit of the solution selected in step (A) in at least one value category using the “as is” and “what if” key parameters from the spreadsheets.

10. The method of claim 9, further comprising the steps of:
(G) selecting a plurality of the solutions;
(H) calculating the “what if” key parameters based on use of each of the solutions selected in step (G).

11. The method of claim 9, further comprising the step of:
(G) altering the values of at least certain of the “as is” key parameters in the spreadsheets to reflect a variation of the model.

12. The method of claim 9, wherein step (F) includes calculating the benefit of the selected solution in each of a plurality of value categories.

13. The method of claim 9, wherein the model represents an operating profile of a commercial airline operation.

14. The method of claim 9, further comprising the step of:
(G) linking the spreadsheets, such that a change in a key parameter in one of the one of the spreadsheets results in corresponding change to the same key parameter in the other spreadsheets.

15. The method of claim 9, further including the steps of:
(G) linking a layout page to the spreadsheets;
(H) displaying the benefit calculated in step (F) in the layout page.

16. A system for evaluating proposed solutions to improve enterprise operations, comprising:
a first software spreadsheet workbook containing information representing a plurality of solutions for improving the operations of an enterprise;
a second software spreadsheet workbook containing information representing a plurality of value models for assessing the value of improvements provided by each of the solutions;
a third software spreadsheet workbook linking the first and second spreadsheet workbooks, the third workbook containing key parameters representing a model of the enterprise operations; and,
a computer programmed for accessing the information in each of the workbooks and for calculating the value of the improvements provided by each of the solutions for each of the value models using the key parameters.

17. The system of claim 16, wherein each of the first, second and third workbooks includes a spreadsheet having first and second sets of key parameter values, the first set of key parameter values representing the model without the improvements provided by the solutions, and a second set of key parameter values representing the model with the improvements provided by one of the solutions.

18. The system of claim 16, wherein one of the workbooks includes a layout spreadsheet in which a user may alter the key parameters.

19. The system of claim 16, wherein one of the workbooks includes a spreadsheet providing a user interface for displaying information related to the value of the improvements.

20. The system of claim 16, wherein each of the workbooks includes an interface spreadsheet, each of the interface spreadsheets including a first set of key parameter values representing the model without any improvements provided by the solutions, and a second set of key parameter values representing the model with improvements provided by one of the solutions.

21. The system of claim 20, wherein the interface spreadsheets are linked such that a change in a key parameter value in one of the spreadsheets results in the same change to the same key parameter value in the other spreadsheets.
